(19) United States
(12) Patent Application Publication
(10) Pub. No.: US 2026/0047517 A1
(43) Pub. Date: Feb. 19, 2026

(54) POWER LAWN MOWER WITH FOOTPLATE

(71) Applicant: Wright Manufacturing, Inc., Frederick, MD (US)

(72) Inventors: Michael D. Hering, Frederick, MD (US); Cory M. Weems, Ijamsville, MD (US); Edward R. Wright, Frederick, MD (US)

(21) Appl. No.: 18/805,619

(22) Filed: Aug. 15, 2024

Related U.S. Application Data
(60) Provisional application No. 63/682,462, filed on Aug. 13, 2024.

(51) Int. Cl. A01D 34/82; A01D 34/64; A01D 101/00

(52) U.S. Cl. CPC A01D 34/82; A01D 34/64; A01D 2101/00

(57) ABSTRACT

A lawn mower may include at least one of: (a) recessed channel(s) in a fuel tank configured for receiving hydraulic hose(s); (b) hydraulic reservoirs, for hydraulic fluid for corresponding transmissions, mounted on a plate and configured to be easily removable for fuel tank access; (c) a fuel tank including a protruding tower including a fuel gauge, where the fuel gauge is configured to be viewable through a hole in a dash panel of the mower and mounted substantially flush with the hole in the dash panel plate; (d) a pivotable and removable thigh pad for stand-on applications where the thigh pad is configured to be easily removable by hand without the need for any tool; (e) a pivotal footplate with angle portions for receiving respective feet of a mower operator; (f) a support under the footplate, where cross members of the support are angled upwardly in order to increase clearance at bottom sides of the mower inside rear drive wheels, such as for improved curb clearance during mower operations and/or to provide for more efficient use of space; (g) an improved interlock design for selectively locking mower pivotal hand controls upon pulling of a parking brake lever/handle; and/or (h) at least one dampening washer (e.g., felt washer) and bearing structure positioned and configured to reduce vibration and/or oscillation/movement of pivotal mower hand controls.

### CROSS-REFERENCE TO RELATED APPLICATION

This application is related to and claims priority on U.S. Provisional Application No. 63/682,462, filed Aug. 13, 2024, the disclosure of which is hereby incorporated herein by reference in its entirety for all purposes.

### FIELD

Certain example embodiments relate to a lawn mower. In certain example embodiments, the lawn mower may be a power lawn mower that includes one or more of: (a) recessed channel(s) in an exterior of a fuel tank configured for receiving hydraulic hose(s); (b) hydraulic reservoirs, for hydraulic fluid for corresponding transmissions, mounted on a plate and configured to be easily removable for fuel tank access; (c) a fuel tank including a protruding tower including a fuel gauge, where the fuel gauge is configured to be viewable through a hole in a dash panel of the mower and mounted substantially flush with the hole in the dash panel plate; (d) a pivotable and removable thigh pad for stand-on applications where the thigh pad is configured to be easily removable by hand without the need for any tool; (e) a pivotal footplate with angle portions for receiving respective feet of a mower operator; (f) a support under the footplate, where cross members of the support are angled upwardly in order to increase clearance at bottom sides of the mower inside rear drive wheels, such as for improved curb clearance during mower operations and/or to provide for more efficient use of space; (g) an improved interlock design for selectively locking mower pivotal hand controls upon pulling of a parking brake lever/handle; and/or (h) at least one dampening washer (e.g., felt washer) and bearing structure positioned and configured to reduce vibration and/or oscillation/movement of pivotal mower hand controls; and/or (i) any combination of (a) through (h).

### BACKGROUND & SUMMARY

Lawn mowers are known in the art. For example, stand-on mowers are discussed in U.S. Pat. Nos. 6,138,446, 6,390,225, 6,189,304, 6,438,930, 6,658,831, 6,560,952, 7,428,884 and 5,964,082, the disclosures of all of which are all hereby incorporated herein by reference in their entireties. Example walk-behind lawn mowers are discussed in U.S. Patent Documents 2005/0126146 and 4,920,733, the disclosures of which are all hereby incorporated herein by reference in their entireties. Example mower operable by seated occupants are discussed in U.S. Patent Documents 2001/0001170, 2002/0059788, U.S. Pat. Nos. 6,438,930, 6,658,831, 6,560,952, 7,325,388, and RE49,179, the disclosures of which are all hereby incorporated herein by reference in their entireties.

Certain example embodiments relate to a lawn mower that may include one or more of: (a) recessed channel(s) in an exterior of a fuel tank configured for receiving hydraulic hose(s); (b) hydraulic reservoirs, for hydraulic fluid for corresponding transmissions, mounted on a plate and configured to be easily removable for fuel tank access; (c) a fuel tank including a protruding tower including a fuel gauge, where the fuel gauge is configured to be viewable through a hole in a dash panel of the mower and mounted substantially flush with the hole in the dash panel plate; (d) a pivotable and removable thigh pad for stand-on applications where the thigh pad is configured to be easily removable by hand without the need for any tool; (e) a pivotal footplate with angle portions for receiving respective feet of a mower operator; (f) a support under the footplate, where cross members of the support are angled upwardly in order to increase clearance at bottom sides of the mower inside rear drive wheels, such as for improved curb clearance during mower operations and/or to provide for more efficient use of space; (g) an improved interlock design for selectively locking mower pivotal hand controls upon pulling of a parking brake lever/handle; and/or (h) at least one dampening washer (e.g., felt washer) and bearing structure positioned and configured to reduce vibration and/or oscillation/movement of pivotal mower hand controls. Example mowers may include one of these features (a)-(h), two of these features, three of these features, four of these features, five of these features, six of these features, seven of these features, or all eight of these features in different example embodiments.

In certain example embodiments, therein may be provided a lawn mower comprising: at least one cutting blade configured to be driven for cutting grass; a footplate configured to support feet of a standing operator of the mower during mower operations, wherein the footplate comprises a foot supporting surface including a central portion and first and second side portions for supporting respective feet of the operator during turns and/or sidehill operations, the central portion being located between at least the first and second side portions of the foot supporting surface, each of the first and second side portions of the foot supporting surface defining an angle of from about 8-40 degrees with the central portion of the foot supporting surface; and a support under and at least partially overlapped by the footplate, wherein the support comprises a central support portion between at least first and second cross supports, wherein the first and second cross supports of the support are each angled upwardly from the central support portion of the support by from about 8-40 degrees in order to increase clearance at bottom sides of the mower.

### BRIEF DESCRIPTION OF THE DRAWINGS

FIG. 1 is a perspective view of a power lawn mower according to an example embodiment.

FIG. 2 is a rear plan view of the power lawn mower of FIG. 1, according to an example embodiment.

FIG. 3 is a top view of at least a handle control assembly, part of a fuel tank, and dash panel of the mower of FIGS. 1-2, according to an example embodiment.

FIG. 4 is an exploded view of a hydraulic system of the mower of FIGS. 1-3 showing at least hydraulic fluid lines running between corresponding hydraulic fluid reserve tanks and respective integrated transmissions, according to an example embodiment.

FIG. 5 is an exploded view of part of the hydraulic system shown in FIG. 4 removed from the mower of FIGS. 1-3, according to an example embodiment.

FIG. 6 is a perspective view of the console cross brace for supporting the hydraulic fluid reserve tanks and to be mounted to the frame upright, of the mower of FIGS. 1-5, according to an example embodiment.

FIG. 7 is an exploded view of the console cross brace, hydraulic fluid reservoirs, and hydraulic fluid lines of the mower of FIGS. 1-6, showing how the hydraulic fluid reservoirs are to be mounted on the console cross brace, according to an example embodiment.

FIG. 8 is a perspective view of an example integrated transmission, for the left rear drive wheel, of the power lawn mower of FIGS. 1-9, according to an example embodiment.

FIG. 9 is a perspective view of an example integrated transmission, for the right rear drive wheel, of the power lawn mower of FIGS. 1-9, according to an example embodiment.

FIG. 10 is a perspective view of the frame upright weldment of the mower of FIGS. 1-9, according to an example embodiment.

FIG. 11 is a front view of the frame upright weldment of the mower of FIGS. 1-10, as viewed from the front of the mower, according to an example embodiment.

FIG. 12 is a rear view of the frame upright weldment of the mower of FIGS. 1-11, as viewed from behind the mower, according to an example embodiment.

FIG. 13 is a side view of the frame upright weldment of the mower of FIGS. 1-12, as viewed from the right side of the mower, according to an example embodiment.

FIG. 14 is a side view of the frame upright weldment of the mower of FIGS. 1-13, as viewed from the left side of the mower, according to an example embodiment.

FIG. 15 is a perspective view of the fuel tank of the mower of FIGS. 1-14, according to an example embodiment.

FIG. 16 is a top view of the fuel tank of the mower of FIGS. 1-15, according to an example embodiment.

FIG. 17 is a rear view of the fuel tank of the mower of FIGS. 1-16, as viewed from behind the mower, according to an example embodiment.

FIG. 18 is a front view of the fuel tank of the mower of FIGS. 1-17, as viewed from in front of the mower, according to an example embodiment.

FIG. 19 is a side view of the fuel tank of the mower of FIGS. 1-18, as viewed from the left side of the mower, according to an example embodiment.

FIG. 20 is a side perspective view of at least a pivotal removable thigh pad in a closed position, handle control assembly, dash panel, and upright weldment of the mower of FIGS. 1-19, according to an example embodiment.

FIG. 21 is a side view of at least the pivotal removable thigh pad in a closed position, handle control assembly, and upright weldment of the mower of FIGS. 1-20, as viewed from the left side of the mower, according to an example embodiment.

FIG. 22 is a side view of at least the pivotal removable thigh pad in a closed position, handle control assembly, and upright weldment of the mower of FIGS. 1-21, as viewed from the right side of the mower, according to an example embodiment.

FIG. 23 is a perspective view of the pivotal removable thigh pad assembly of the mower of FIGS. 1-22, according to an example embodiment.

FIG. 24 is an exploded view of the pivotal removable thigh pad assembly of the mower of FIGS. 1-23, showing how the thigh pad is attached to a thigh pad support, according to an example embodiment.

FIG. 25 is a side view of at least the pivotal removable thigh pad assembly in a pivoted upward and opened position, handle control assembly, and upright weldment of the mower of FIGS. 1-24, as viewed from the right side of the mower, according to an example embodiment.

FIG. 26 is a side view of at least the pivotal removable thigh pad assembly in a pivoted upward and opened position, handle control assembly, and upright weldment of the mower of FIGS. 1-25, as viewed from the left side of the mower, according to an example embodiment.

FIG. 27 is a side view of at least the pivotal removable thigh pad assembly in a pivoted upward and opened position, handle control assembly, and upright weldment of the mower of FIGS. 1-26, as viewed from the left side of the mower during a thigh pad assembly removal process after the step shown in FIG. 26, according to an example embodiment.

FIG. 28 is a side view of at least the pivotal removable thigh pad assembly in a pivoted upward and opened position, handle control assembly, and upright weldment of the mower of FIGS. 1-27, as viewed from the left side of the mower during a thigh pad assembly removal process after the step shown in FIG. 27, according to an example embodiment.

FIG. 29 is a side view of at least the pivotal removable thigh pad assembly in a pivoted upward and opened position, handle control assembly, and upright weldment of the mower of FIGS. 1-28, as viewed from the right side of the mower during a thigh pad assembly removal process after the step shown in FIG. 28, according to an example embodiment.

FIG. 30 is a perspective exploded view of at least the pivotal removable thigh pad assembly in a removed state after being removed, handle control assembly, and upright weldment of the mower of FIGS. 1-29, according to an example embodiment.

FIG. 31 is a perspective exploded view of at least the pivotal removable thigh pad assembly in a removed state after being removed, handle control assembly, and upright weldment of the mower of FIGS. 1-30 (from a different viewpoint than FIG. 30), according to an example embodiment.

FIG. 32 is a perspective view of the mower of FIGS. 1-31 on a curb from a bottom rear of the mower, showing at least the pivotal footplate, support under the footplate, and rear drive wheels according to an example embodiment.

FIG. 33 is a perspective view of the mower of FIGS. 1-32 from a rear of the mower, showing at least the pivotal footplate, support under the footplate, and rear drive wheels according to an example embodiment.

FIG. 34 is a rear plan view of the mower of FIGS. 1-33 from directly behind the mower, showing at least the pivotal footplate, support under the footplate, and rear drive wheels according to an example embodiment.

FIG. 35 is a side plan view of a portion of the mower of FIGS. 1-34 from the right side of the mower with right rear wheel removed for simplicity, showing at least the pivotal footplate, support under the footplate within the radius of the rear wheel(s) as viewed from the side, cutter deck, and left rear drive wheel according to an example embodiment.

FIG. 36 is a side perspective cutaway view of a portion of the mower of FIGS. 1-35 from the right rear of the mower with right rear drive wheel removed for simplicity, showing at least the pivotal footplate, support under the footplate, and transmission according to an example embodiment.

FIG. 37 is a side perspective cutaway view of a portion of the mower of FIGS. 1-36 from the right rear of the mower with right rear drive wheel removed for simplicity, showing at least the pivotal footplate, support under the footplate, and transmission according to an example embodiment, with FIG. 37 being closer than FIG. 36.

FIG. 38 is a perspective view of the footplate of the mower of FIGS. 1-37, according to an example embodiment.

FIG. 39 is a perspective view of the frame with cross support member of the mower of FIGS. 1-38, according to an example embodiment.

FIG. 40 is an exploded perspective view showing at least part of an interlock system for selectively locking mower pivotal hand controls, including at least one dampening washer (e.g., felt washer) and bearing structure, of the mower of FIGS. 1-39 according to an example embodiment.

FIG. 41 is an exploded perspective view of the interlock with rod ends of FIG. 40, according to an example embodiment.

FIG. 42 is a perspective view showing the interlock system with the brake lever pulled/on and locking the mower pivotal hand controls, of the mower of FIGS. 1-41, according to an example embodiment.

FIG. 43 is a top view of the interlock system and hand controls of the mower of FIGS. 1-42, according to an example embodiment.

FIG. 44 is an exploded perspective view of the interlock system and hand controls of the mower of FIGS. 1-43, showing where the dampening washer is located, according to an example embodiment.

FIG. 45 is a perspective view showing part of the interlock system in a locked position locking the mower pivotal hand controls, of the mower of FIGS. 1-44, according to an example embodiment.

FIG. 46 is a side view showing the interlock system with the brake lever not pulled so that the parking brake is off and the mower pivotal hand controls are in an unlocked state, of the mower of FIGS. 1-45 according to an example embodiment.

FIG. 47 is a perspective and partially exploded view showing at least part of the interlock system, dash panel, hydraulic fluid reservoirs, and handle controls of the mower of FIGS. 1-46, according to an example embodiment.

FIG. 48 is an exploded perspective view of part of the interlock system and hand controls of the mower of FIGS. 1-47, showing at least the dampening washer and adjacent bearing structure, according to an example embodiment.

FIG. 49 is an exploded view of the dampening washer and adjacent bearing structure of FIG. 48, according to an example embodiment.

FIG. 50 is an exploded cross-sectional view of the dampening washer and adjacent bearing structure of FIGS. 48-49, according to an example embodiment.

FIG. 51 is a perspective cross-sectional view of the dampening washer and adjacent bearing structure of FIGS. 48-50, according to an example embodiment.

FIG. 52 is a cross-sectional view of the dampening washer and adjacent bearing structure of FIGS. 48-51, according to an example embodiment.

### DETAILED DESCRIPTION OF CERTAIN EXAMPLE EMBODIMENTS

Referring now more particularly to the accompanying drawings in which like reference numerals indicate like parts throughout the several views.

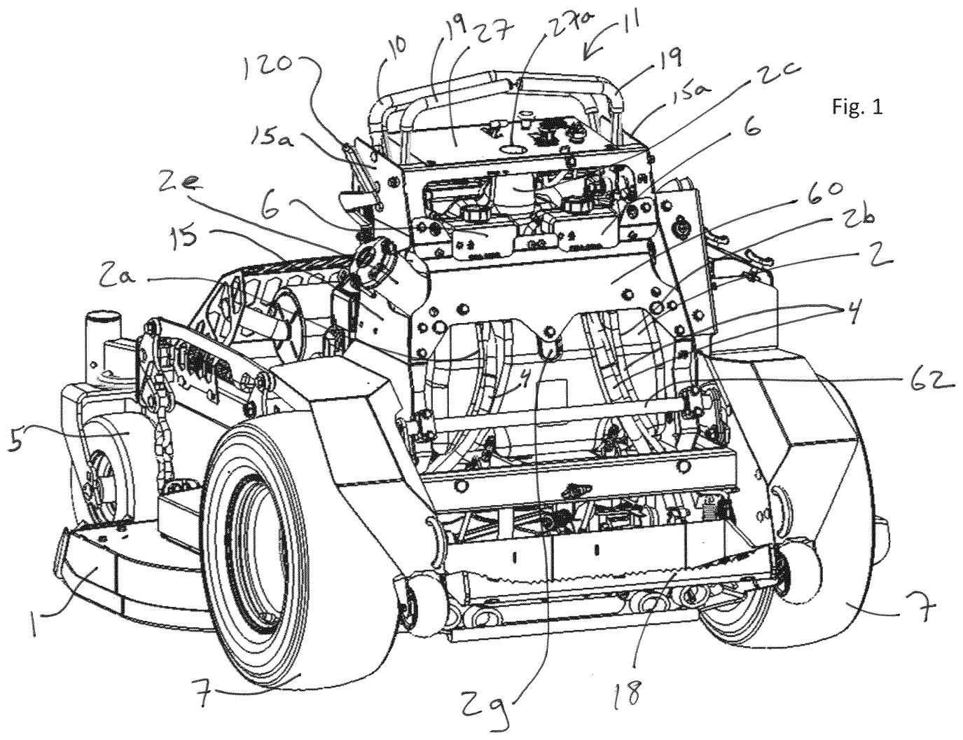

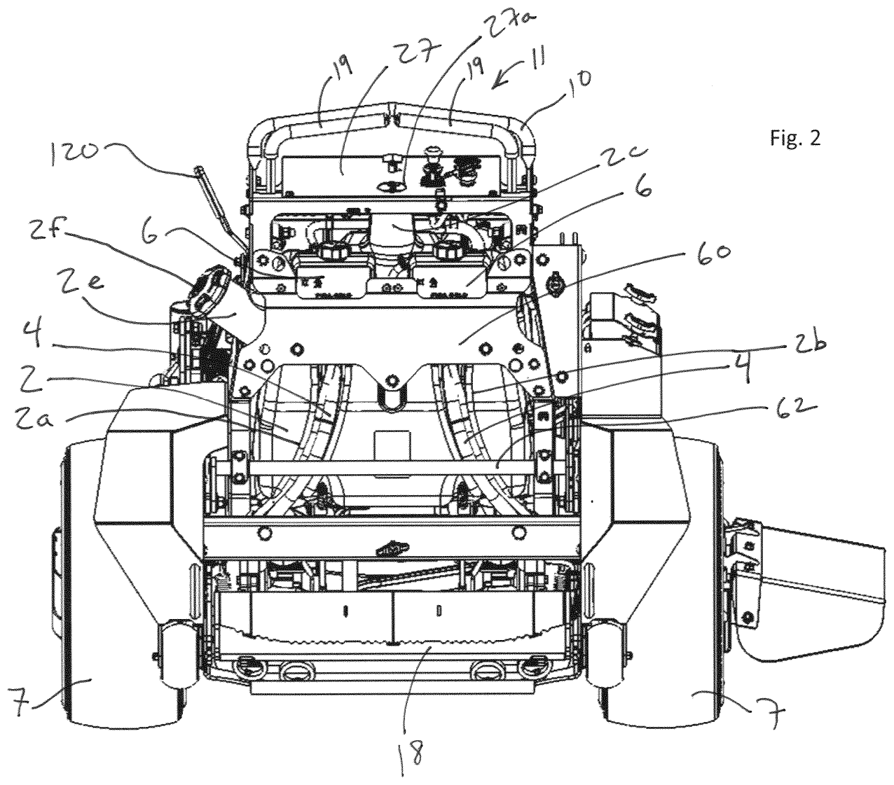

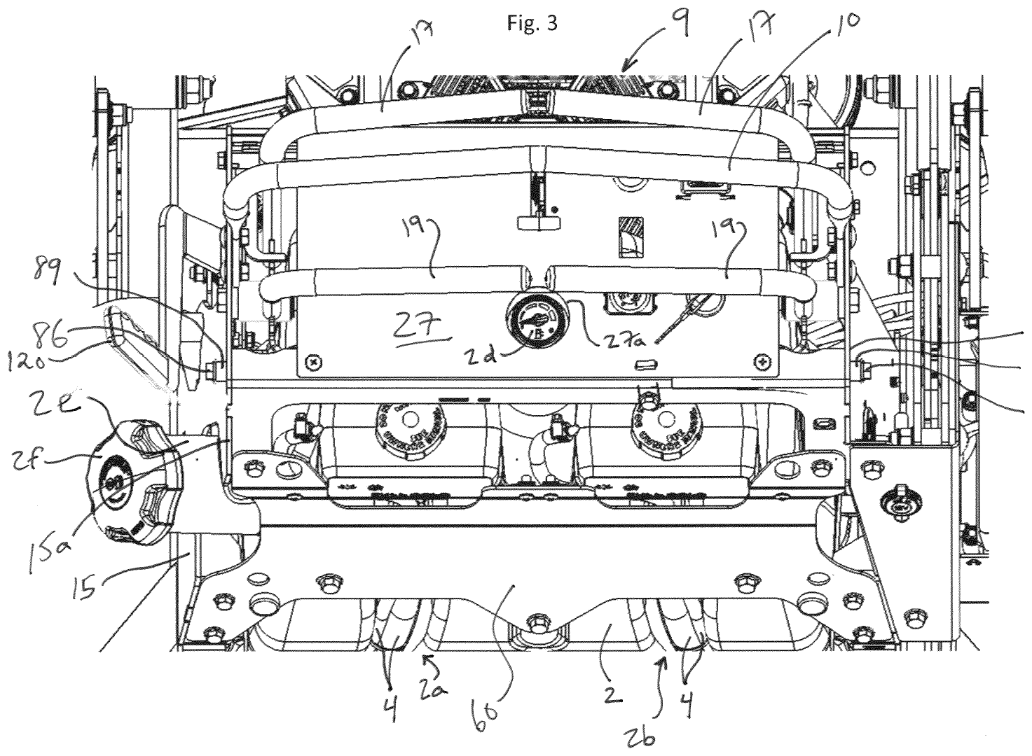

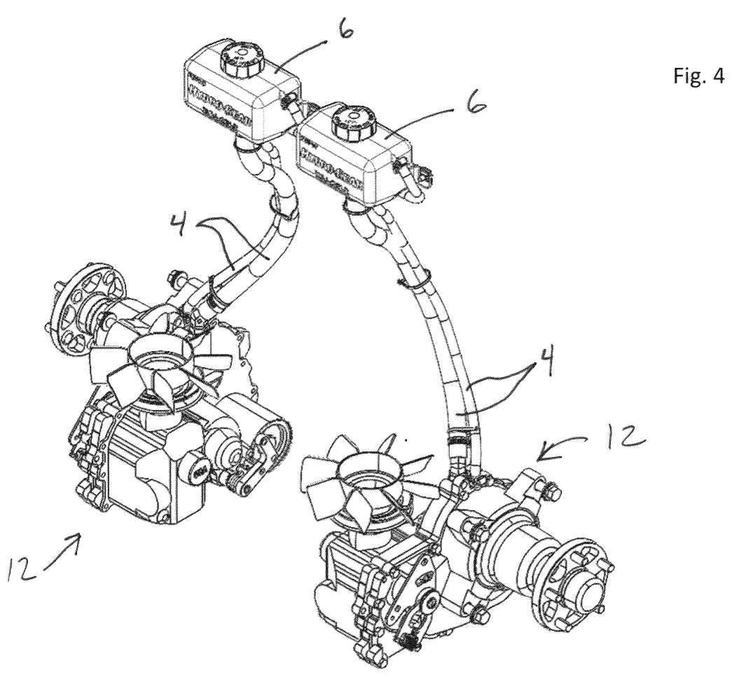

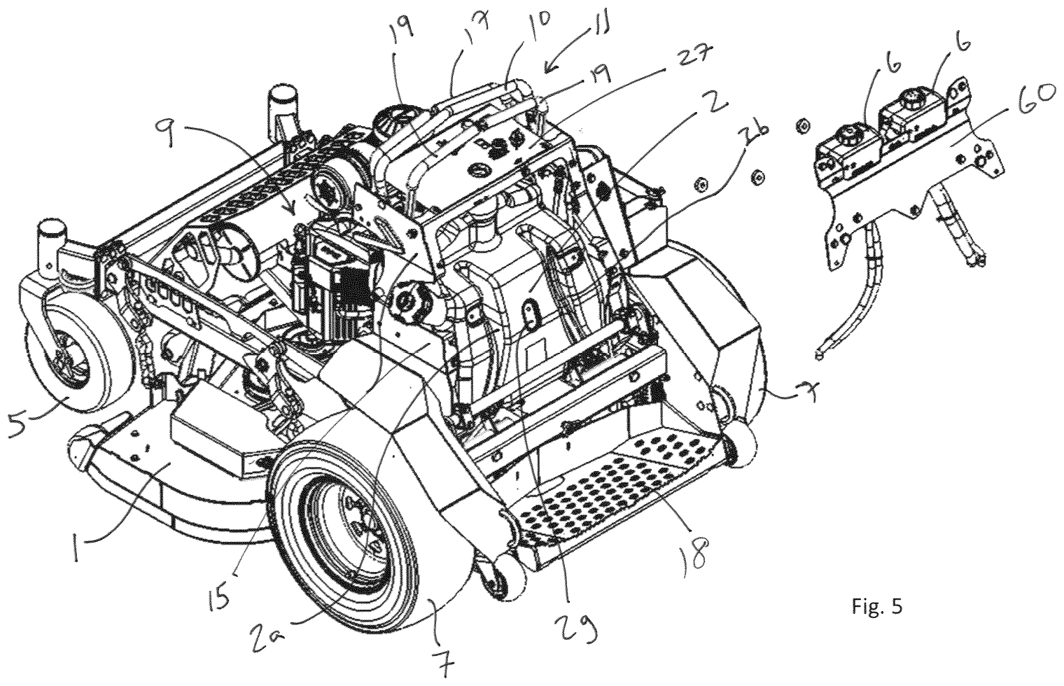

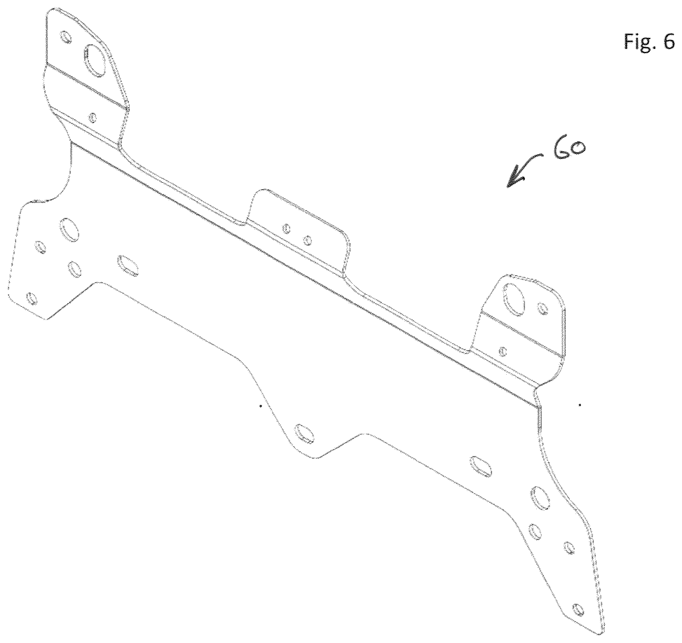

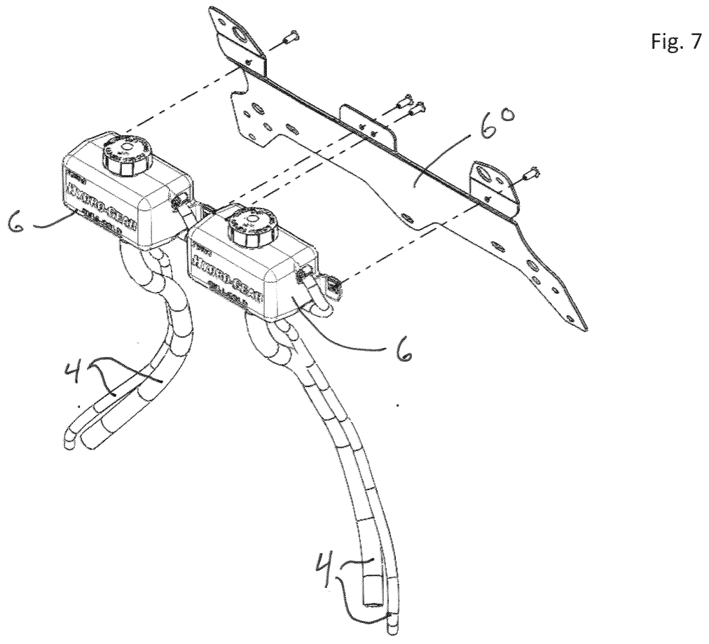

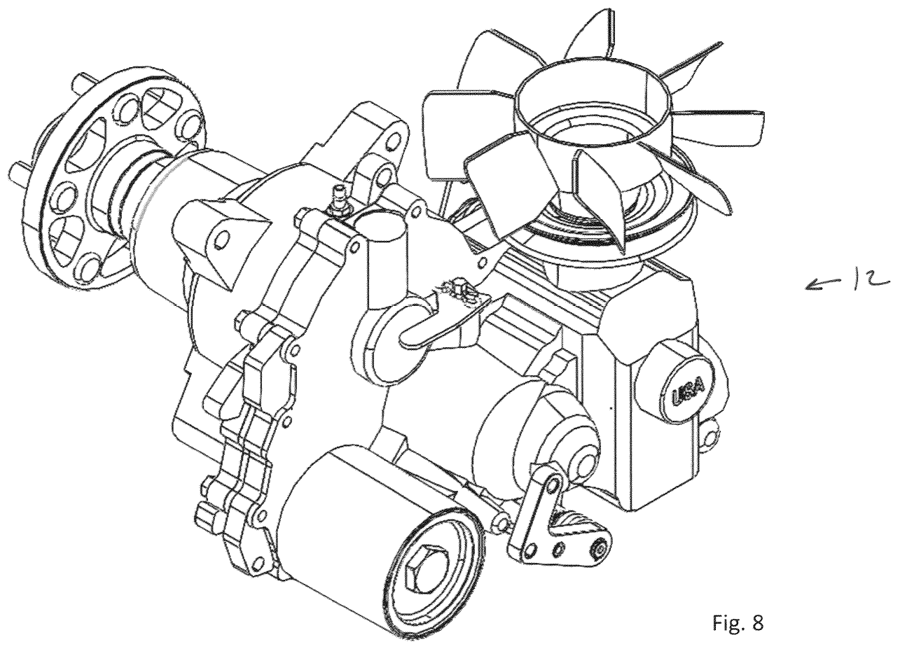

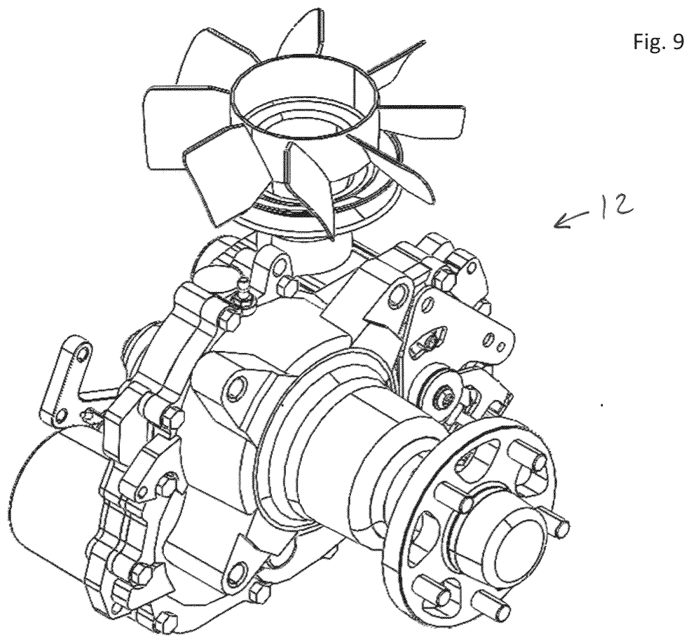

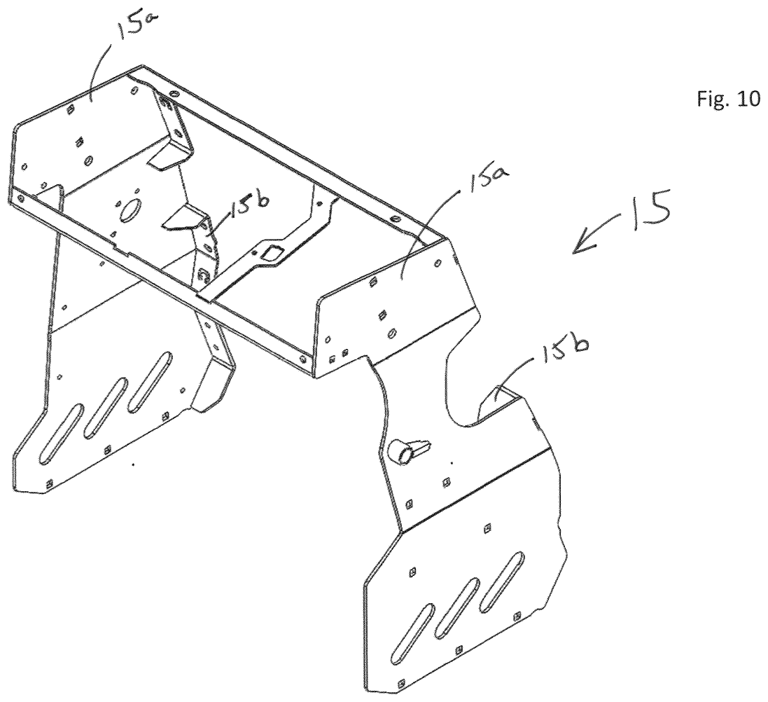

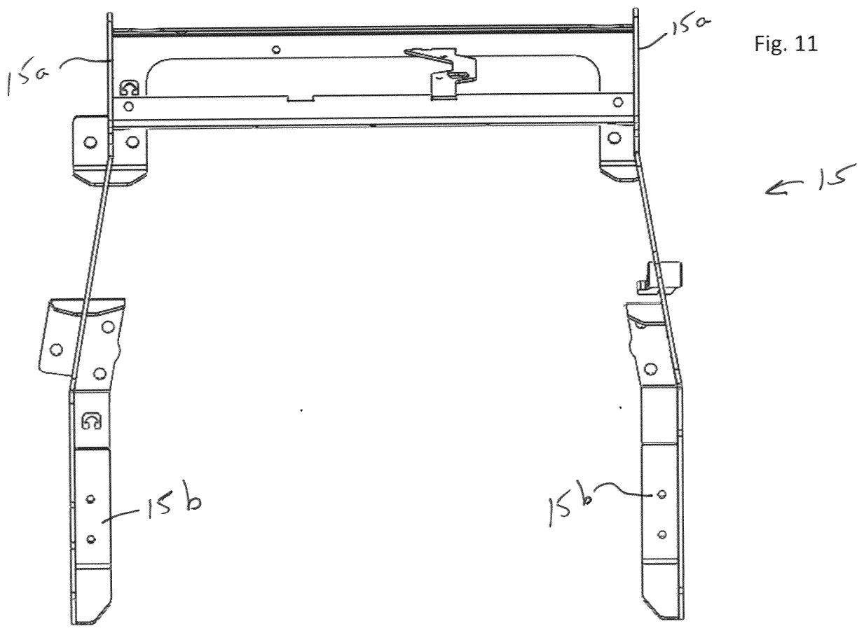

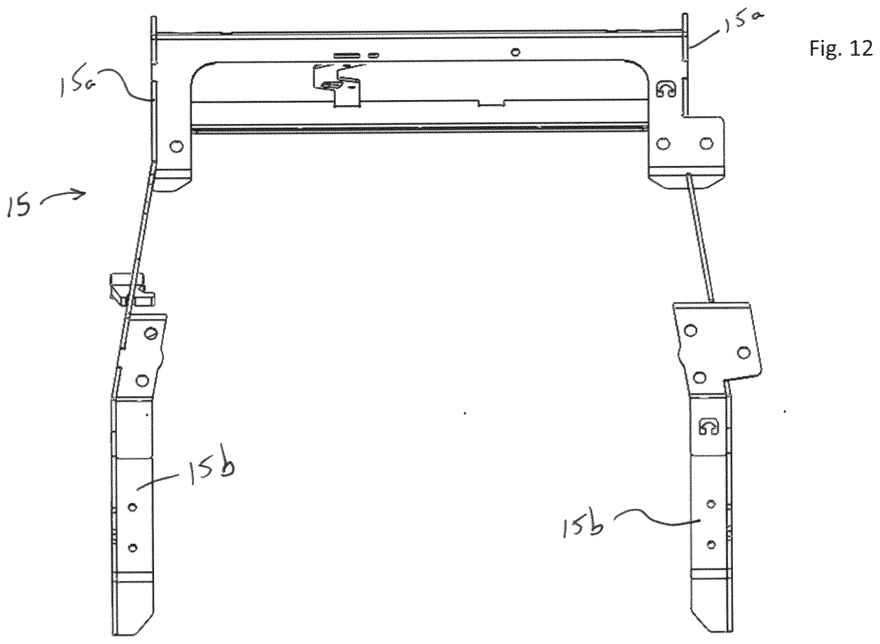

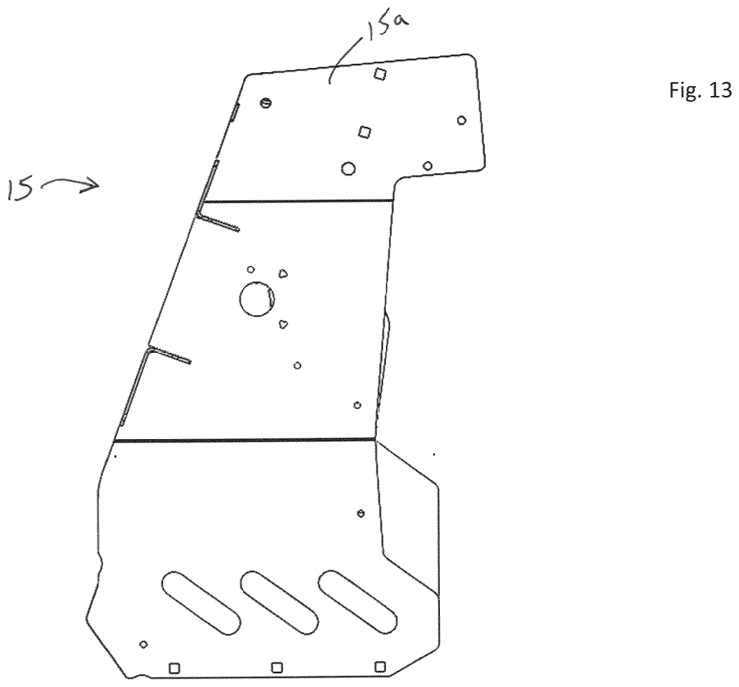

FIGS. 1-13 illustrate an example power mower according to an example embodiment. FIG. 1 is a perspective view of a power lawn mower according to an example embodiment; FIG. 2 is a rear plan view of the power lawn mower of FIG. 1, according to an example embodiment; and FIG. 3 is a top view of at least a handle control assembly 11, part of a fuel tank 2, and dash panel 27 of the mower of FIGS. 1-2, according to an example embodiment; FIG. 4 is an exploded view of a hydraulic system of the mower of FIGS. 1-3 showing at least hydraulic fluid lines 4 running between corresponding hydraulic fluid reserve tanks 6 and respective integrated transmissions 12, according to an example embodiment; and FIG. 5 is an exploded view of part of the hydraulic system shown in FIG. 4 removed from the mower of FIGS. 1-3, according to an example embodiment; FIG. 6 is a plan view of a console cross brace 60 for supporting the hydraulic fluid reserve tanks 6 and to be mounted to the frame upright 15; FIG. 7 is an exploded view of the console cross brace 60, hydraulic fluid reservoirs 6, and hydraulic fluid lines 4 of the mower of FIGS. 1-6, showing how the hydraulic fluid reservoirs 6 are to be mounted on the console cross brace 60 in an example embodiment; FIGS. 8-9 are perspective views of an example integrated transmissions for the left and right rear drive wheels respectively; FIG. 10 is a perspective view of the frame upright weldment 15 of the mower of FIGS. 1-9 according to an example embodiment; and FIGS. 11-13 are various other views of the frame upright weldment 15 according to an example embodiment.

Note that the thigh pad 13 is omitted from certain figures, including being omitted from FIGS. 1-5, for purposes of simplicity so as to better see other features of the mower.

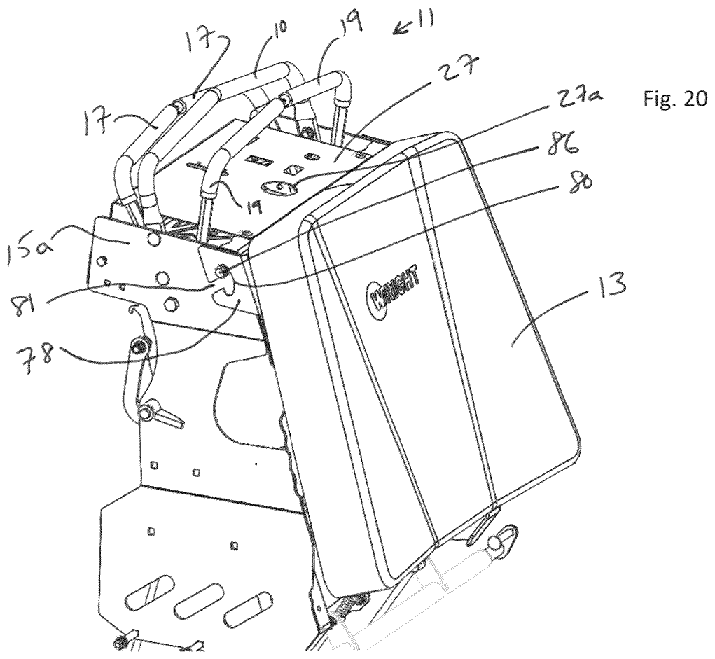

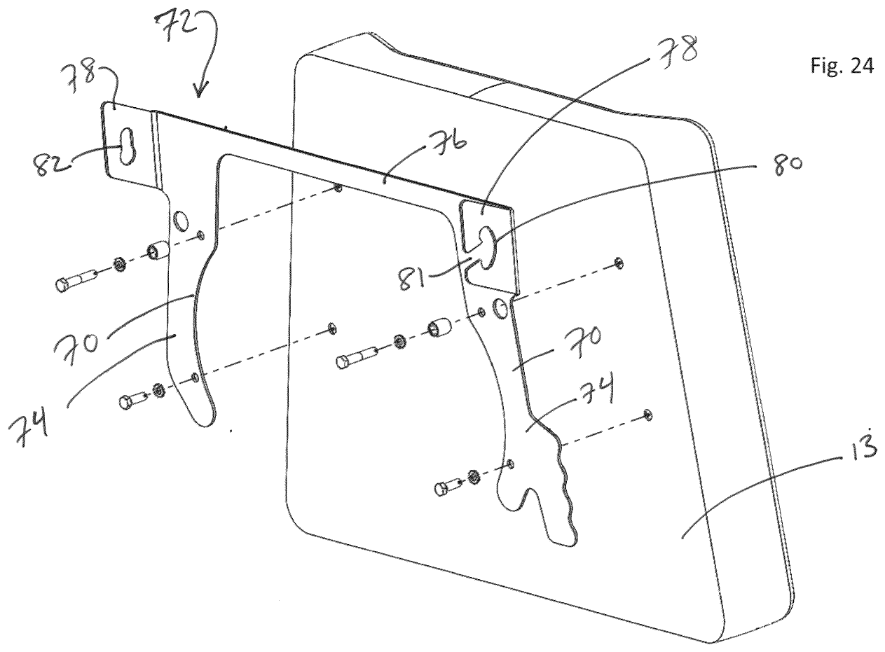

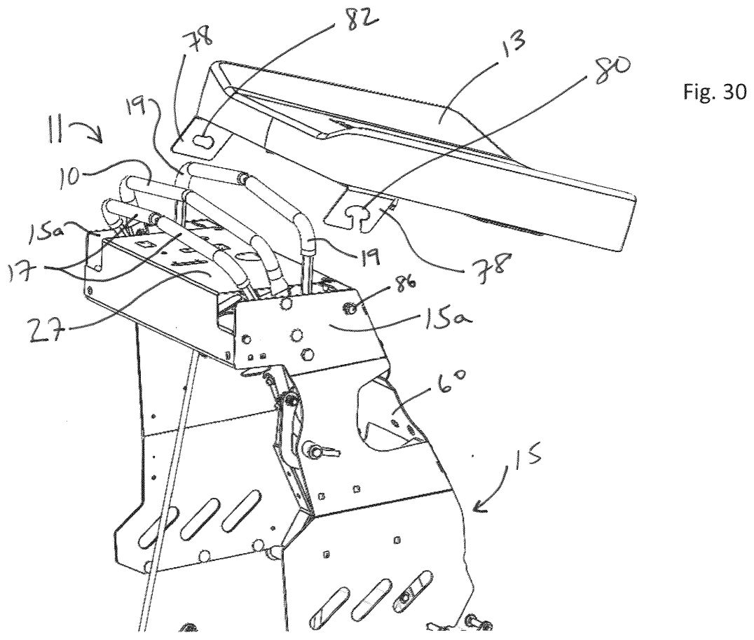

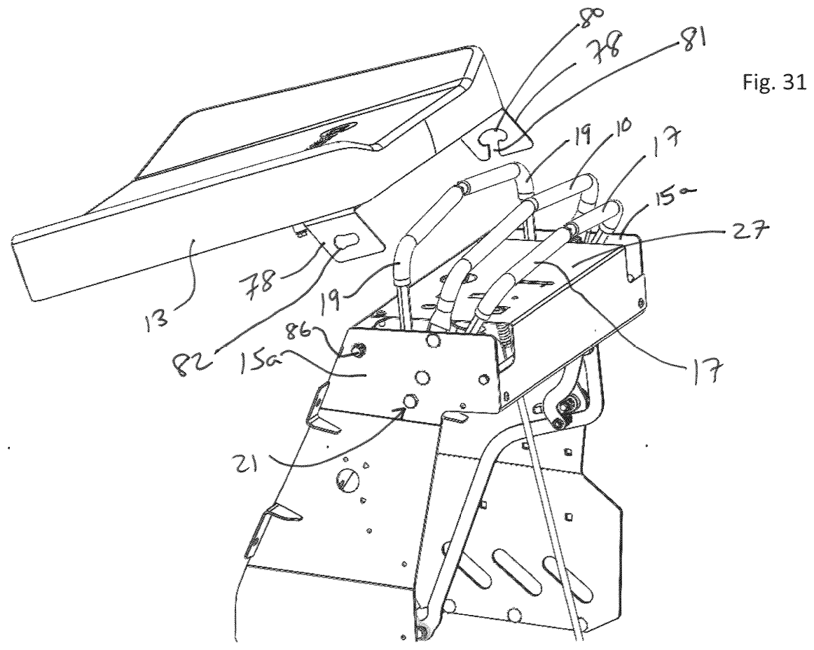

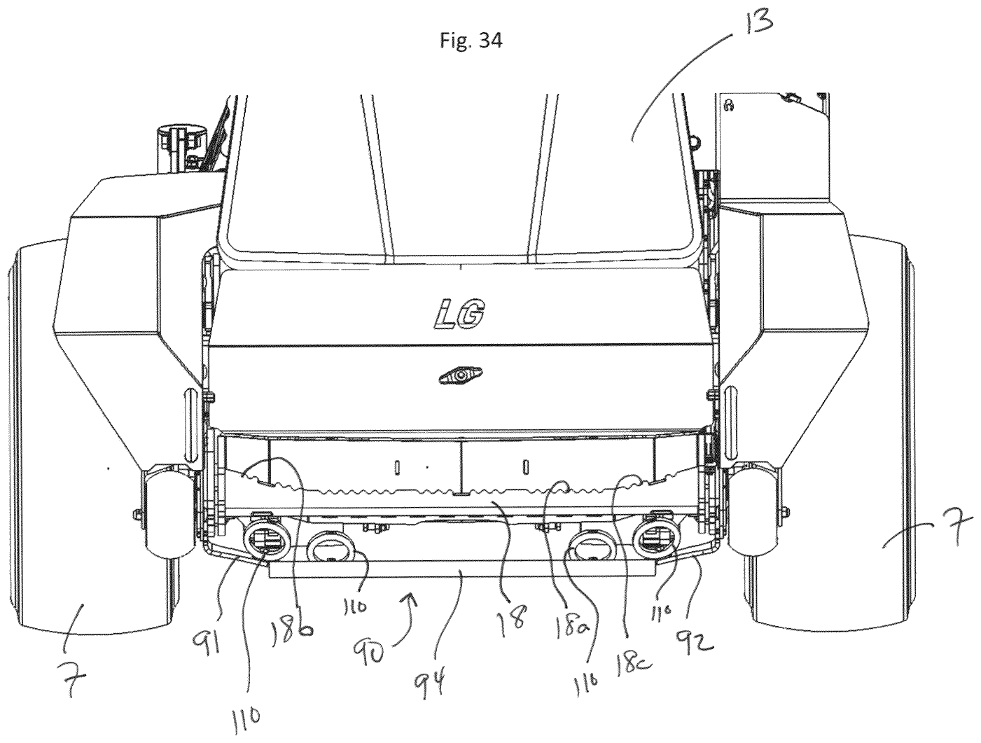

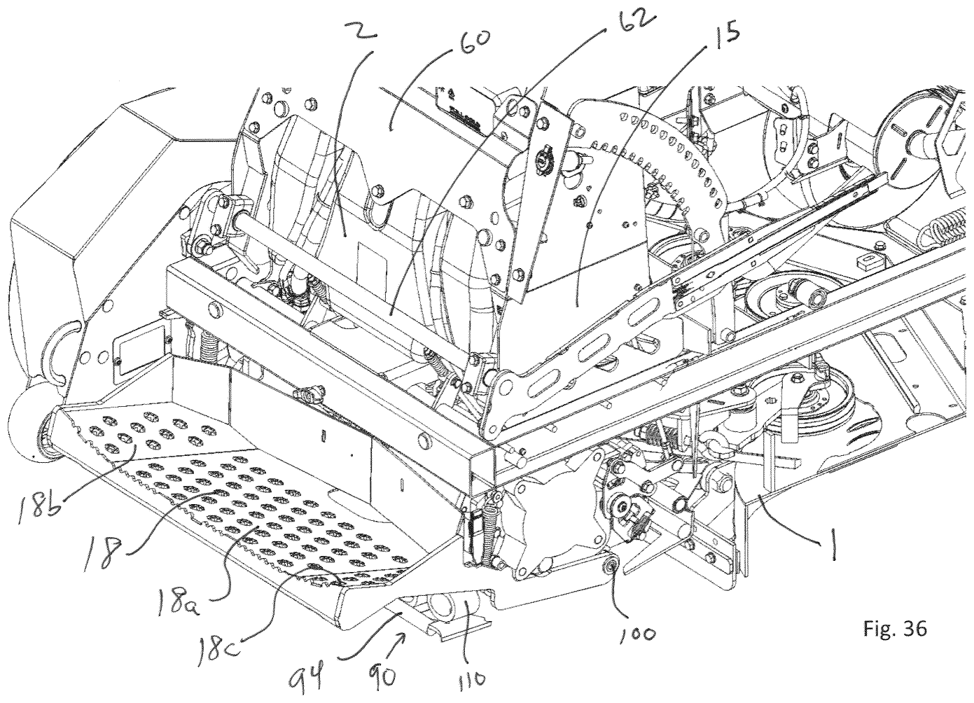

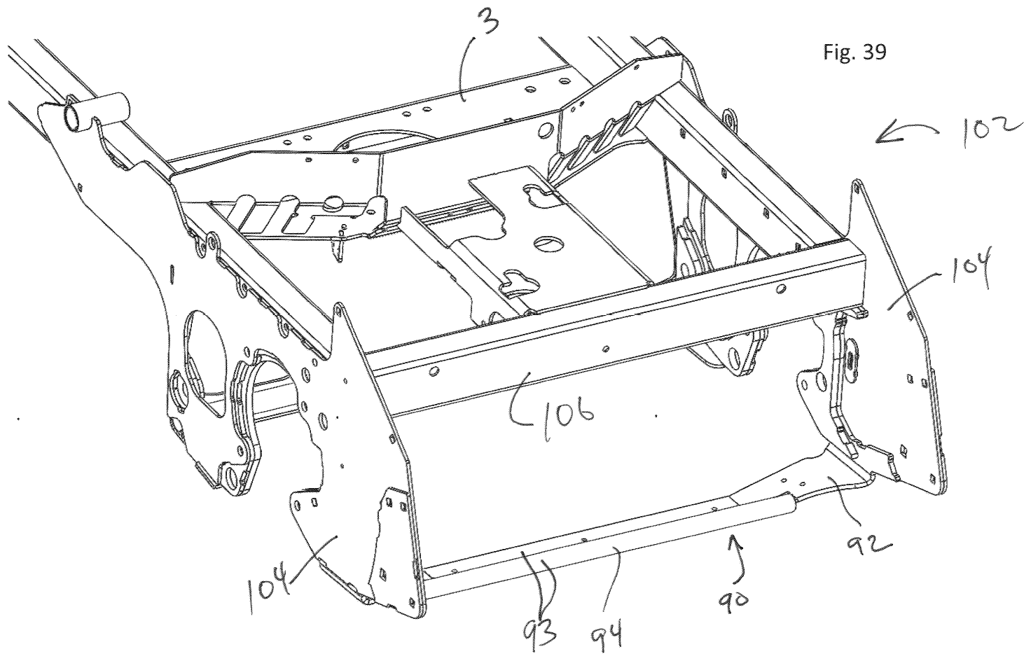

Referring to various figures, the mower includes cutter deck 1 for housing one or more grass cutting blades, engine deck 3 (e.g., see also FIG. 39), a pair of front caster wheels 5, a pair of rear drive wheels 7, thigh pad 13 (e.g., see FIGS. 20-34) for permitting the operator to rest his/her thighs thereon during operation, frame upright weldment 15 to support thigh pad 13, cross brace 60 for supporting hydraulic fluid reserve tanks 6 and connected between opposing upright sides of upright weldment 15, dash panel 27, handle control assembly 11, combustion engine 9 which operates based on fuel (e.g., gas) from fuel tank 2, rear lift deck axle 62, and pivotal operator support footplate 18 for supporting feet of an operator during mower operation. The handle control assembly 11 includes rigid handle bar 10 rigidly connected to upper supports 15a of upright weldment, reverse control levers 17, and forward control levers 19. Upright supports 15a may be referred to as part of, or as, upright sides in certain example instances, and may be substantially parallel to each other and on opposite sides of the mower in certain example embodiments. Control levers 17 and 19 are pivotally affixed to supports 15a about axis 21 so that the operator can control the steering of the mower via the rear drive wheels 7 by pivoting levers 17 and/or 19 during operation. A deck lift lever (e.g., shown extending forward from axle 62 in FIG. 36) may be used to selectively raise and/or lower the cutter deck 1 and cutting blades. The mower is of the zero radius turning type in certain example embodiments, with the wheels being hydraulically driven via respective hydrostatic transmissions 12. While an example embodiment shown in the figures relates to a stand-on mower for use by a standing operator, certain features herein may be used in other types of mowers such as mowers that can be operated by a walking operator or a sitting operator. Thus, mower in various example embodiments may or may not include a seat. Components such as cutter deck 1, engine deck 3, upright weldment 15, cross brace 60, footplate 18, thigh pad support plate 70, and/or dash panel 27 may be of or include metal such as steel, or any other suitable material, in various example embodiments. As shown in FIG. 10 for example, upright weldment 15 may include first and second spaced apart upright supports 15a at least portions of which are substantially vertically oriented, wherein the first upright support is provided on a left side of the mower and the second upright support is provided on a right side of the mower as viewed from behind the mower; and at least one cross member support may be connected between the upright supports 15a as shown in FIG. 10.

An example mower includes a pair of drive wheels 7, each of which is independently operated by a hydraulic and/or hydrostatic transmission 12. Example integrated transmissions are shown in FIGS. 8-9. For example, when integrated hydrostatic transmissions are used, such an integrated transmission 12 may include a combination of an axle for connection to the corresponding wheel, a pump, and a motor combined in one unit. A corresponding transmission 12 may be provided for each drive wheel 7. Each transmission can be independently controlled via the handle control levers so that each drive wheel 7 may be selectively driven at variable speeds in both forward and reverse directions. In this manner, the mower may be steered by controlling the speed and direction of the two drive wheels, and may be referred to as a zero radius turning mower. Other types of transmissions may also be used in various example embodiments. Zero radius turns are typically performed when the two drive wheels on a common axis for example are operated at approximately the same speed but in opposite directions so that the mower pivots or turns about a vertical axis extending upwardly from a location between the drive wheels.

Referring to FIGS. 1-7 for example, hydraulic fluid reservoirs 6 for the respective hydrostatic transmissions 12 are mounted at an elevation above at least the majority of fuel tank 2 and are also mounted as viewed from above at least partially between the upper substantially vertically oriented supports 15a of upright weldment 15. Fuel tank 2 may be made of molded polymer based material, or any other suitable material, in various example embodiments. Indeed, as shown in the figures, reservoirs 6 are mounted directly above portions of the fuel tank 2 in certain example embodiments. This mounting location is advantageous in that it improves manufacturability and conserves space in a crowded mower design, and for instance may allow for larger fuel and/or hydraulic fluid tanks to be used due to such a space savings.

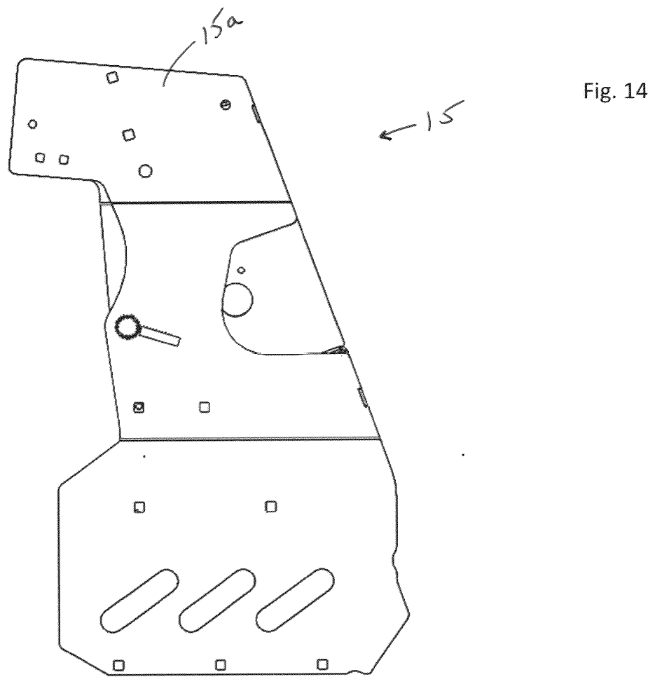

Referring to FIGS. 1-14, and especially to FIGS. 4-7, hydraulic fluid reservoirs 6 may be mounted on cross brace 60 via screws of the like in certain example embodiments. Thus, for example, in certain example embodiments when the cross brace 60 is removed from being connected to upright weldment 15 (e.g., see FIGS. 5, 7), this allows for quick and easy access to and/or removal of fuel tank 2, and/or quick and easy access to other areas of the mower for maintenance or the like, and also provides for improved manufacturability. For instance, during manufacturing, the reservoirs 6 can be connected to cross brace 60 (e.g., see FIG. 7), and then the combined module including the cross brace 60 with reservoirs 6 attached thereto can be mounted to the mower with for example the cross brace 60 being connected to flanges 15b of upright weldment 15 in certain example embodiments via screws, bolts or the like.

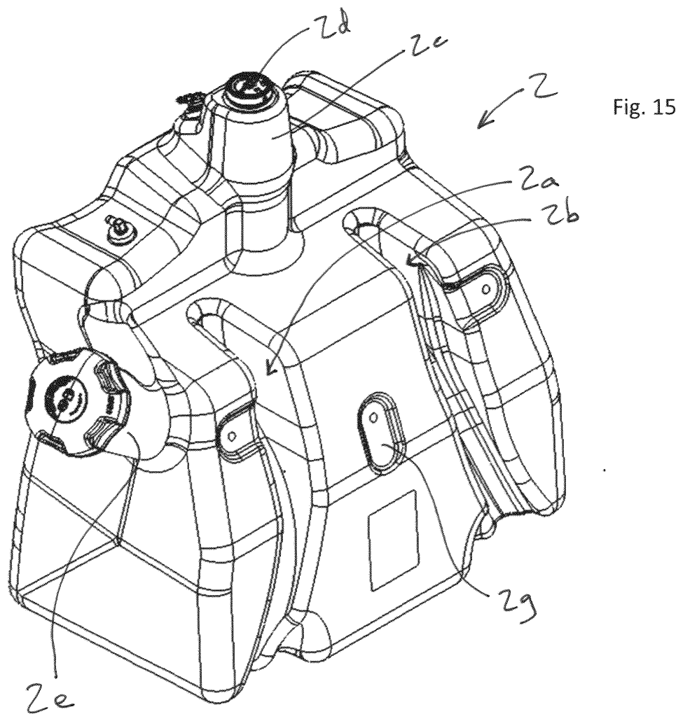

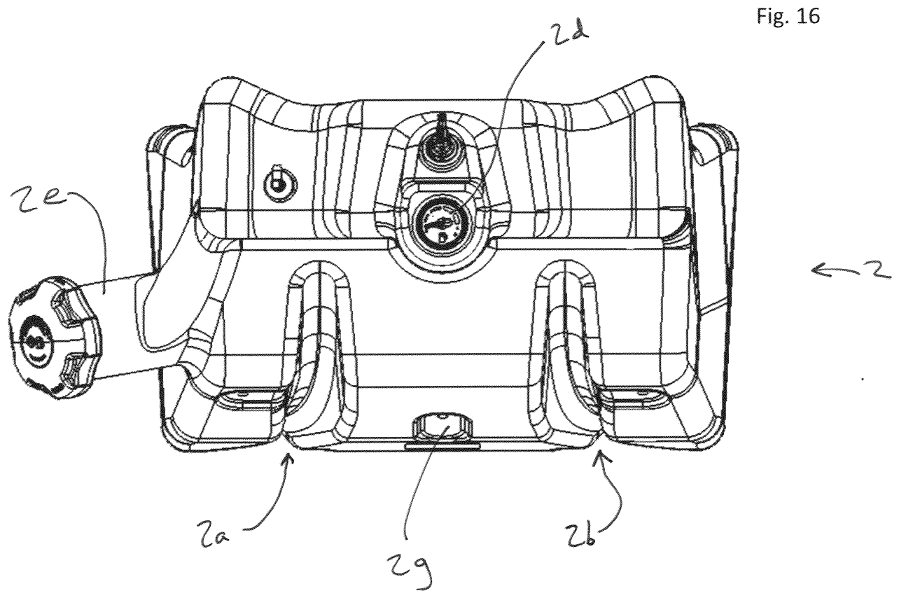

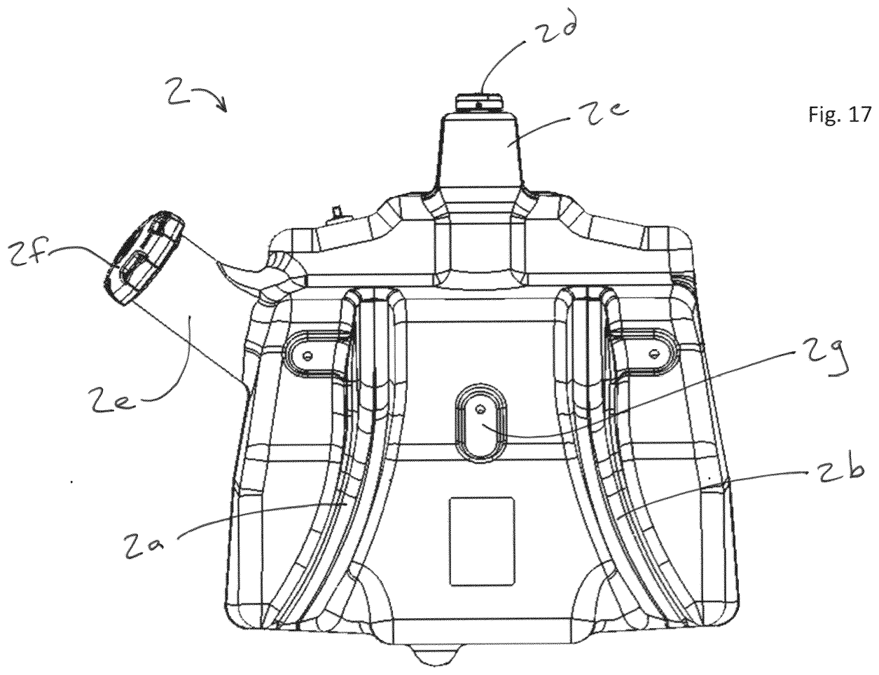

Referring especially to FIGS. 1-17, in order to allow such a design to be commercially desirable, when space is highly valued, recessed channels 2a and 2b may be formed in an exterior of a fuel tank configured for at least partially receiving and routing hydraulic hose(s) 4. Channels 2a and 2b may be formed in a rear surface of the tank 2 in certain example embodiments, as shown in the figures. For example, the recessed channels 2a, 2b in the fuel tank 2 are especially well shown in FIGS. 15-17. This is technically advantageous in that it allows space to be conserved, allows for a larger fuel tank, provides for improved manufacturability, and allows for the hoses 4 to be routed down toward the transmissions 12 without kinking and thus provides for improved mower reliability. Cross brace 60, when mounted on the mower, keeps the hoses/lines 4 in channels 2a, 2b. In certain example embodiments, as shown in the figures, two hydraulic lines 4 may be received in each recessed channel 2a, 2b, although it is possible that just one line 4 may be received in each channel 2a, 2b in certain example embodiments. Lines 4 may be partially, or entirely, provided in recessed channels 2a, 2b in the fuel tank in various example embodiments. As shown in the figures, recessed channels 2a and/or 2b may be oriented so that they extend from an upper and/or top portion of the fuel tank 2 to a bottom or lower portion of the fuel tank, for example as shown in FIGS. 15-17. Thus, at least parts of elongated channels 2a and/or 2b may be substantially vertically oriented in certain example embodiments, and may be at least partially curved for example as shown in FIGS. 15-17.

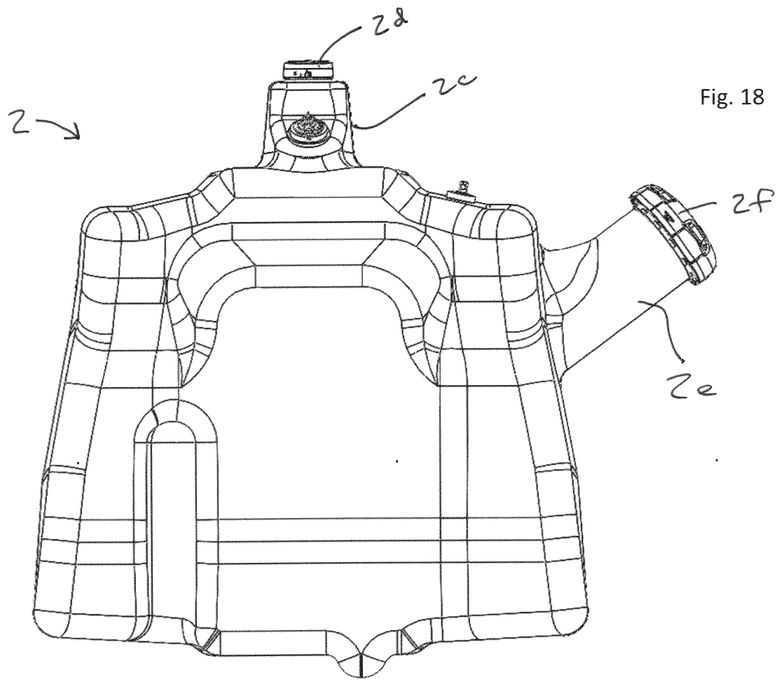

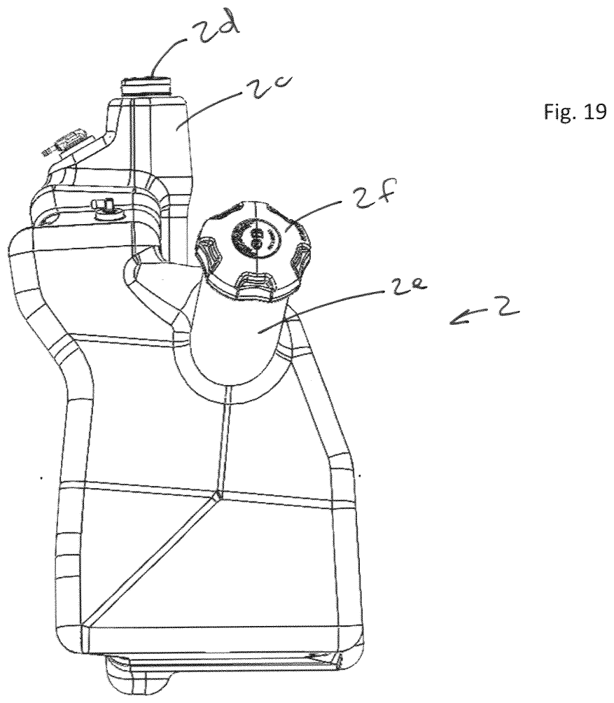

In certain example embodiments, fuel tank 2 may include a protruding tower 2c including a fuel gauge 2d, where the fuel gauge 2d is configured to be viewable through a hole 27a in a dash panel 27 of the mower and be mounted substantially flush (e.g., flush within about +/−one inch in either direction) with the hole 27a in the dash panel plate 27. Gauge 2d is located on top of the protruding tower 2c in certain example embodiments. Fuel gauge 2d being substantially flush with the dash panel 27 is advantageous in that it allows the gauge 2d to be more easily seen/viewed through hole 27a by an operator during mower operations, and also provides for an added level of protection for the gauge. In certain example embodiments, tower 2c protrudes from an upper portion of the fuel tank 2 (e.g., see FIGS. 1-2 and 15-19). In certain example embodiments, tower 2c and gauge 2d as viewed from above may each be located between upper supports 15a of upright weldment 15, no higher than the dash panel 27, and/or forward of cross brace 60, which provides for physical protection of the fuel tank 2 and thus a safer mower and safer operating environment for the operator. In certain example embodiments, selectively openable filler neck 2e of the fuel tank 2 may be located at the side of the fuel tank 2, and may extend though an opening defined between cross brace 60 and upright support weldment 15 as shown in the figures, which provides for added protection for the neck 2e and thus a safer operating environment for an operator. A removable cap 2f may be provided at the top of filler neck 2e. Moreover, in certain example embodiments, recess 2g may be provided at the rear of the fuel tank 2 for receiving an elastomeric (e.g., rubber) washer for dampening vibration between the tank 2 and cross brace 60. In certain example embodiments, the fuel tank 2 may have an evaporation vent proximate a top and/or front thereof, to reduce chances of fuel getting into the evaporation line which leads from the vent to the engine 9.

Referring to at least FIGS. 20-34, in stand-on mower applications, in certain example embodiments, a thigh pad 13 may be provided for permitting the operator to rest his/her thigh(s) thereon during mower operation or otherwise when the operator is standing on footplate 18. In certain example embodiments, there may be provided a thigh pad assembly which may include thigh pad 13 and thigh pad support plate 70 on which the thigh pad is mounted. In certain example embodiments, at least the thigh pad assembly is configured so that the thigh pad assembly is pivotable and removable so as to be easily removable by hand from the mower without the need for any tool. In other words, the thigh pad 13 can be removed from the mower by the operator in an easy and quick manner, without having to use any screwdrivers or wrenches.

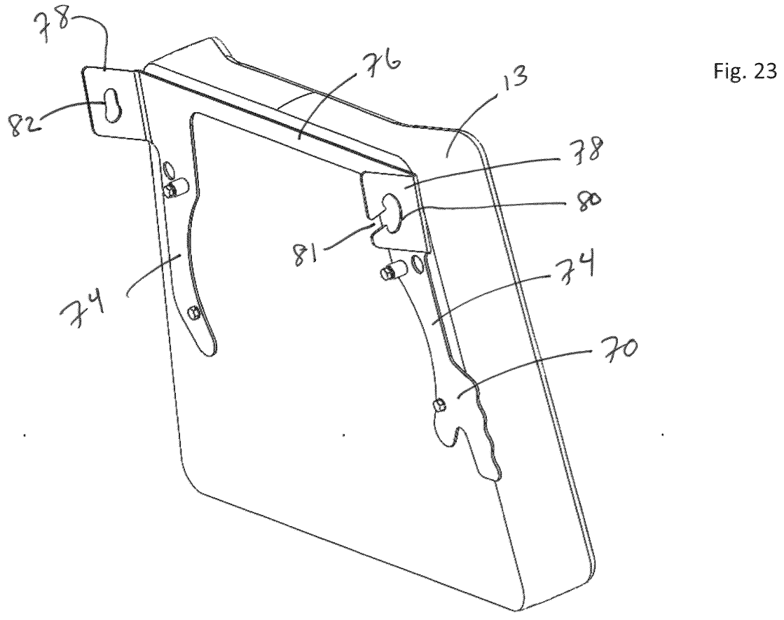

In certain example embodiments, thigh pad support plate 70 may include a substantially U-shaped (other otherwise shaped) support 72 that is substantially parallel with the thigh pad 13, for supporting the pad (e.g., see FIGS. 23-25). Support 72 may include substantially parallel legs 74 which extend from connecting base 76. Support 72 may also include flanges 78, at least one on each side. In certain example embodiments, flanges 78 extend outwardly away from the thigh pad 13 from respective legs 74 and/or base 76 (e.g., see FIGS. 20-34). In certain example embodiments, flanges 78 may be substantially perpendicular to legs 74 and/or base 76, and/or may be substantially parallel to each other (e.g., see FIGS. 20-34).

Differently shaped apertures 80 and 82 are provided on each of the respective flanges 78 (e.g., see FIGS. 20-31) as part of a thigh pad hinge assembly. For example, and shown in the figures, a first aperture 80 (e.g., which may be one or more of substantially mushroom shaped, substantially T-shaped, and/or substantially labyrinth shaped, as shown in the figures), and which includes at least one opening and/or channel 81 so that the aperture is not completely surrounded by the flange, is provided on the flange 78 at one side of the mower; and a differently shaped second aperture 82 (e.g., which may be substantially keyhole shaped as shown in the figures, so as to include first and second holes of different sizes that are contiguous with each other) and which may be completely surrounded by the corresponding flange is defined in the flange 78 at the other side of the mower (e.g., see FIGS. 20-31). These different aperture designs 80 and 82, in combination, are configured to allow the thigh pad assembly, including thigh pad 13 and support 70, to be easily and quickly removed from the mower by hand, by an operator or anyone else, without having to use any screwdrivers or wrenches, and so that the thigh pad assembly will not pop off during mower transport and the like. Other aperture shapes may also be used.

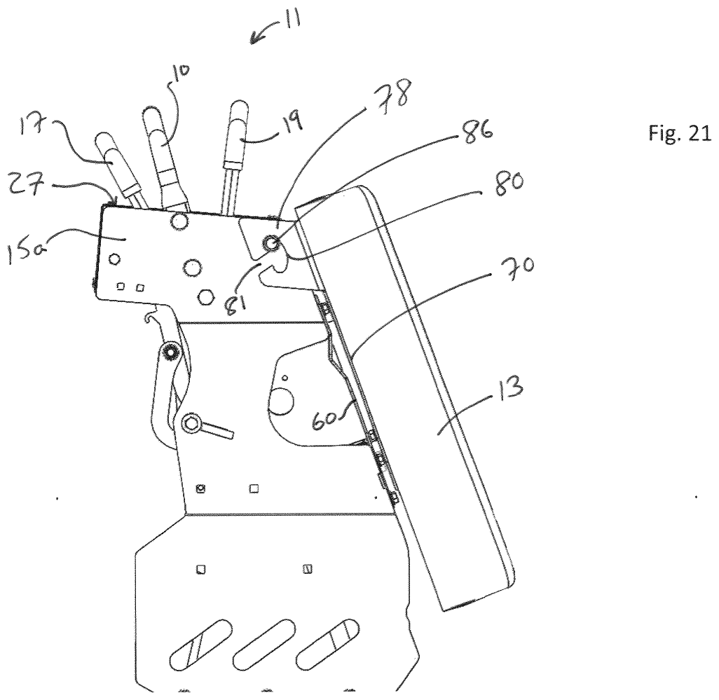

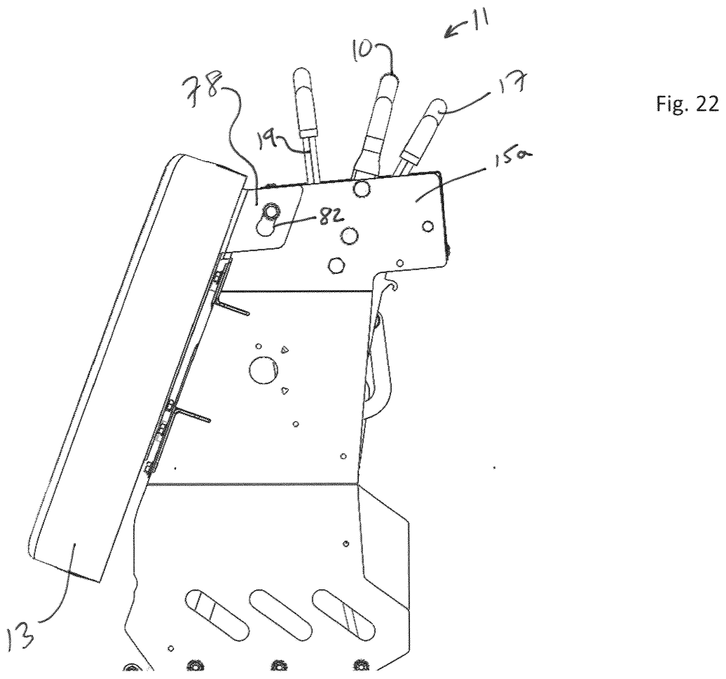

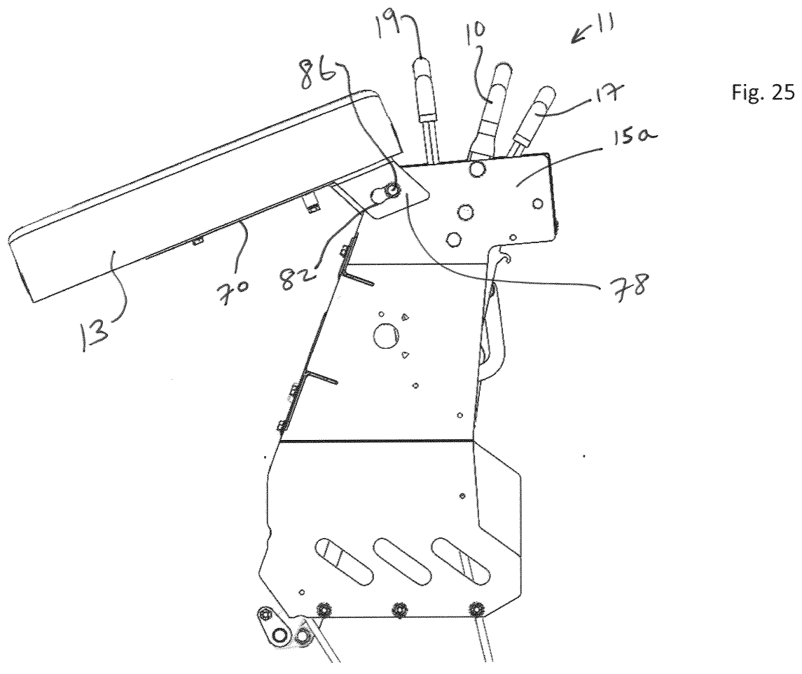

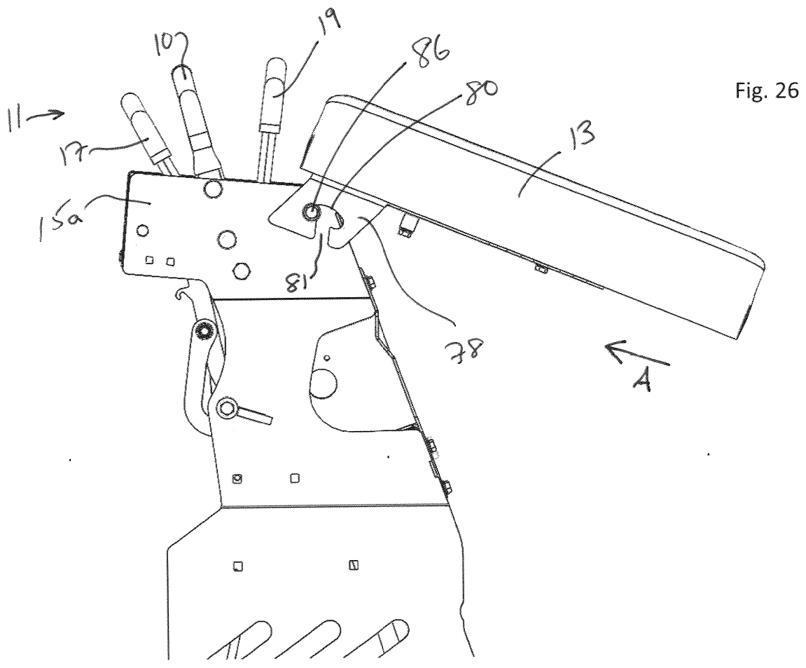

Flanged bolt(s) and/or nut(s) 86 with a spacer 89, for supporting the thigh pad assembly, are affixed to the supports 15a of upright weldment 15 so that one flanged bolt and/or nut and spacer is provided at each side of the mower (e.g., see FIGS. 20-31). Note that the spacers 89, interior of the larger flanges of the nuts/bolts 86, may be most clearly shown in FIG. 3. The first aperture 80 may be substantially mushroom shaped, substantially T-shaped, and/or substantially labyrinth shaped and include an open channel 81, such that the thigh pad assembly 13, 70 can be attached to the mower by sliding the bolt/nut 86 through the channel 81 and then sliding the thigh pad assembly so that gravity causes the thigh pad assembly to come to rest in a position where the flange of the bolt/nut is interior of the channel 81 and in the larger part of the aperture as shown in FIGS. 21 and 26. The bottom portion of the mushroom-shaped aperture 80 is configured so as to prevent or reduce chances of the thigh pad assembly from bouncing off the mower during transport. The second aperture 82 may be substantially keyhole shaped, such that the thigh pad assembly 13, 70 can be attached to the mower by sliding the flange of the bolt/nut 86 through the larger sized hole of the keyhole and then sliding the thigh pad assembly so that gravity causes the thigh pad assembly to come to rest in a position where the flange of the bolt/nut is adjacent the smaller sized hole of the keyhole as shown in FIGS. 22 and 25. When the thigh pad assembly 13, 70 is mounted on the mower, the pair of flanged bolts and/or nuts 86 extend though apertures 80 and 82, respectively, so that the support 70 may rest on the bolt shaft or any other suitable structure such as a spacer (e.g., see spacers 89 in FIG. 3) interior of the flanges of the respective bolts/nuts, and the flanges of the respective nuts/bolts 86 extend beyond the periphery of the apertures thereby holding the thigh pad assembly on the mower (e.g., see FIGS. 20-22). FIG. 20 is a side perspective view of at least a pivotal removable thigh pad assembly 13, 70 in a closed position; FIG. 21 is a side view of at least the pivotal removable thigh pad assembly 13, 70 in a closed position; and FIG. 22 is a side view of at least the pivotal removable thigh pad assembly 13, 70 in the closed position, where FIGS. 21 and 22 are from opposite sides of the mower. The closed position of the thigh pad assembly is preferred during mower operations, so that the operator can rest his/her thighs on the pad 13.

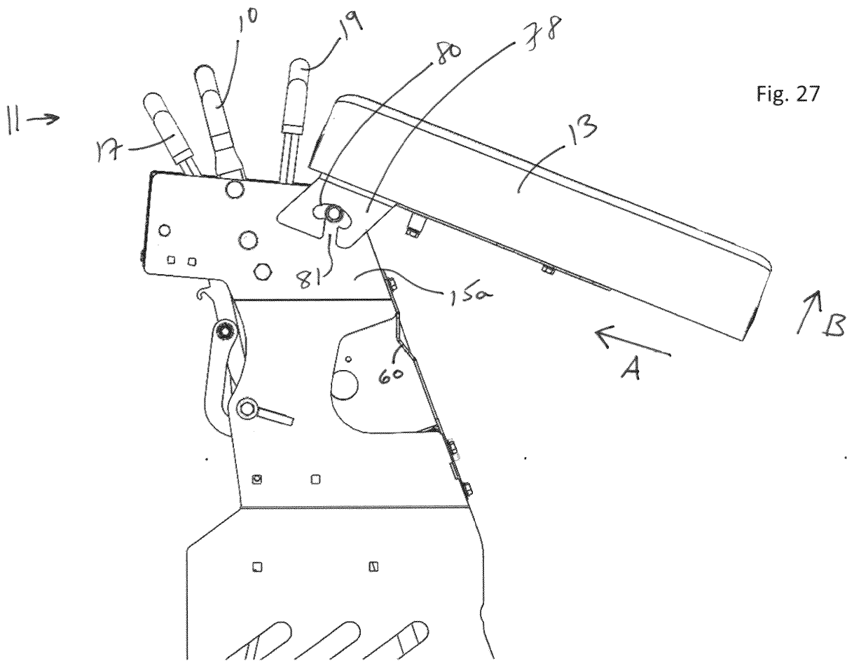

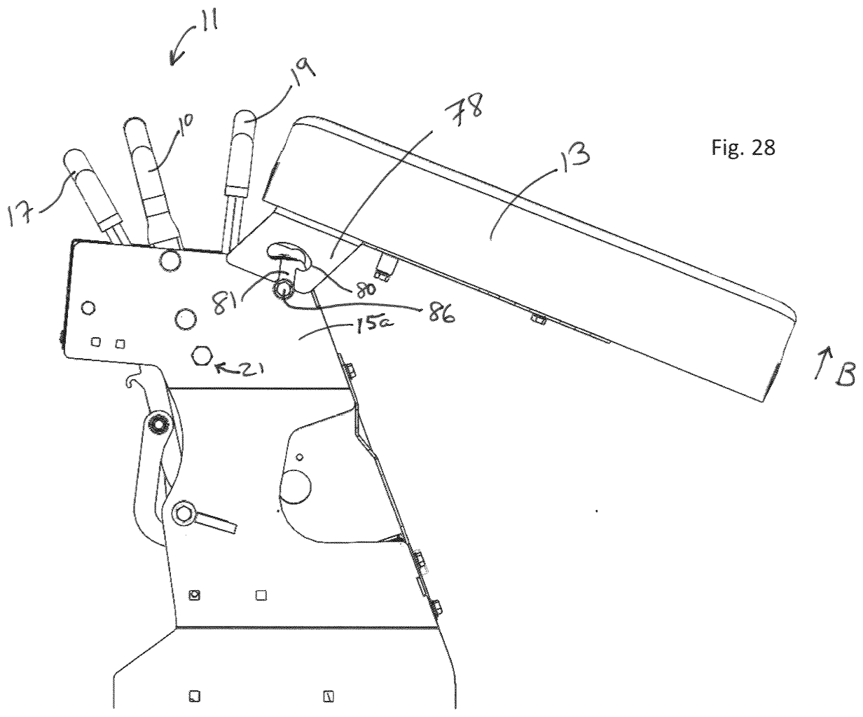

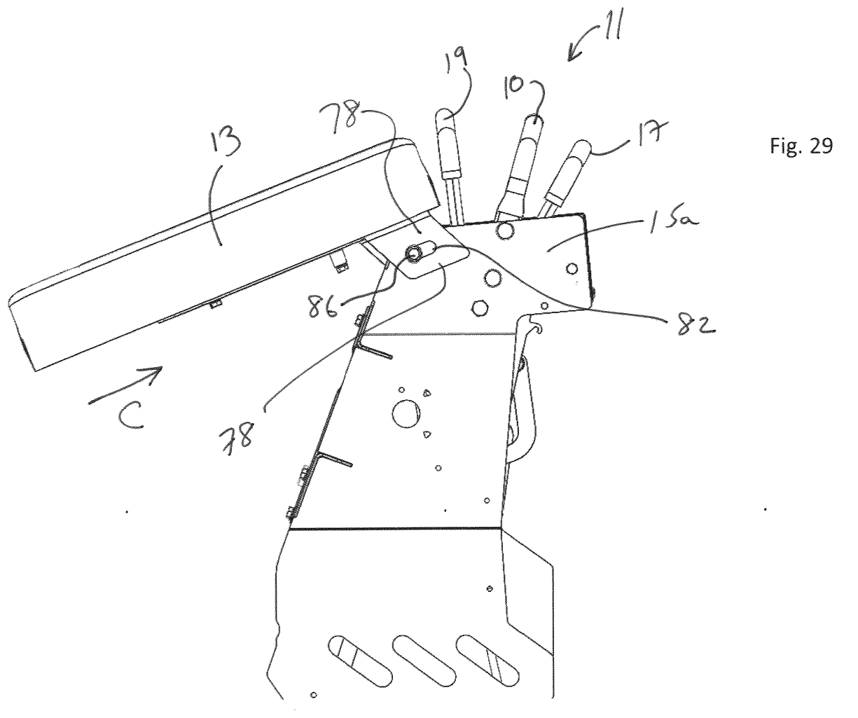

An example technique will now be explained for removing, by hand, the thigh pad assembly 13, 70 from the mower, starting from the closed position shown in FIGS. 20-22. From the closed position shown in FIGS. 20-22, the operator first lifts/pivots the bottom of the pad upward so that the thigh pad assembly pivots about an axis 86 from the closed position shown in FIGS. 20-22 to an open position as shown in FIGS. 25-26. At this point, as shown in FIGS. 25-26, the flanges of the bolts/nuts 86 are still at the upper portions of the apertures 80 and 82 and thus are still holding the thigh pad assembly on the mower. Next, the operator lifts the side of the thigh pad assembly having aperture 80 (but need not lift the side having aperture 82) in approximately direction “A” from the FIG. 26 position to the FIG. 27 position where the bolt/nut 86 is adjacent open channel 81 (e.g., see FIGS. 26-27). The operator then lifts this same side of the thigh pad assembly upwardly in approximately direction “B” from the FIG. 27 position to the FIG. 28 position so that the bolt/nut 86 slides through open channel 81 and this side of the thigh pad assembly becomes removed from the mower. At this point, in the FIG. 28 position, while the side of the pad assembly having aperture 80 has been removed from the mower, the other side of the pad assembly having keyhole shaped aperture 82 is still attached to the mower. Next, the operator slides the thigh pad assembly in direction “C” as shown in FIG. 29 so that the bolt/nut 86 on that side of the mower slides from the smaller hole of the keyhole to the larger sized hole of the keyhole 82. Then, since the opposite side of the thigh pad assembly has already been removed from the mower, the operator moves the thigh pad assembly laterally in the direction out-of-the-page in FIG. 29 and because the larger sized hole of the keyhole is larger in size than the flange of the bolt/nut 86 the flange of the bolt/nut 86 slides through the keyhole and the flange 78 and keyhole shaped aperture 82 and the overall thigh pad assembly become removed from the mower (e.g., see FIGS. 29-31). In such a manner, the thigh pad assembly 13, 70 can be removed from the mower by the operator in an easy and quick manner, without having to use any screwdrivers or wrenches.

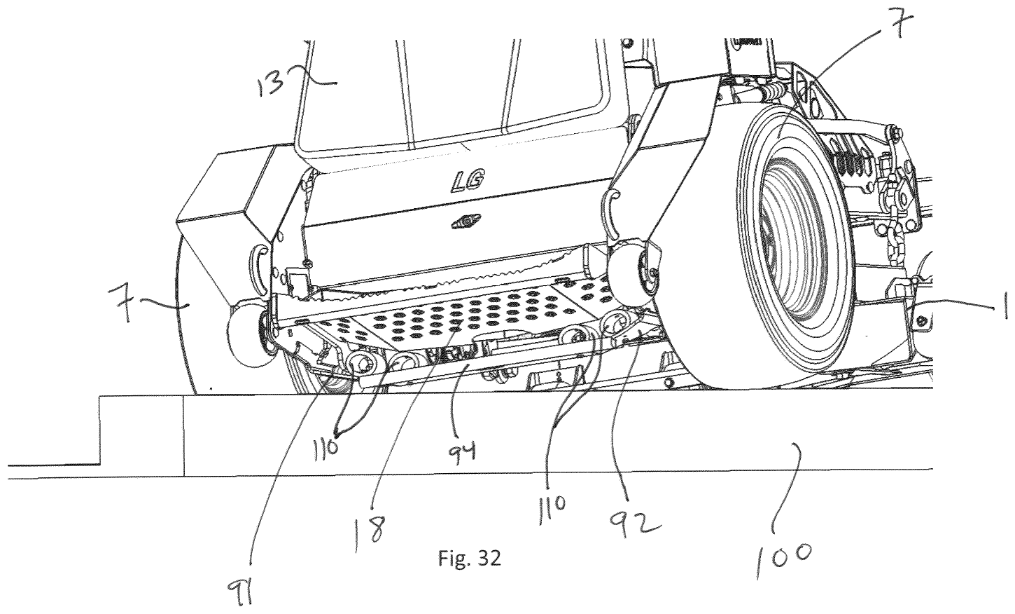

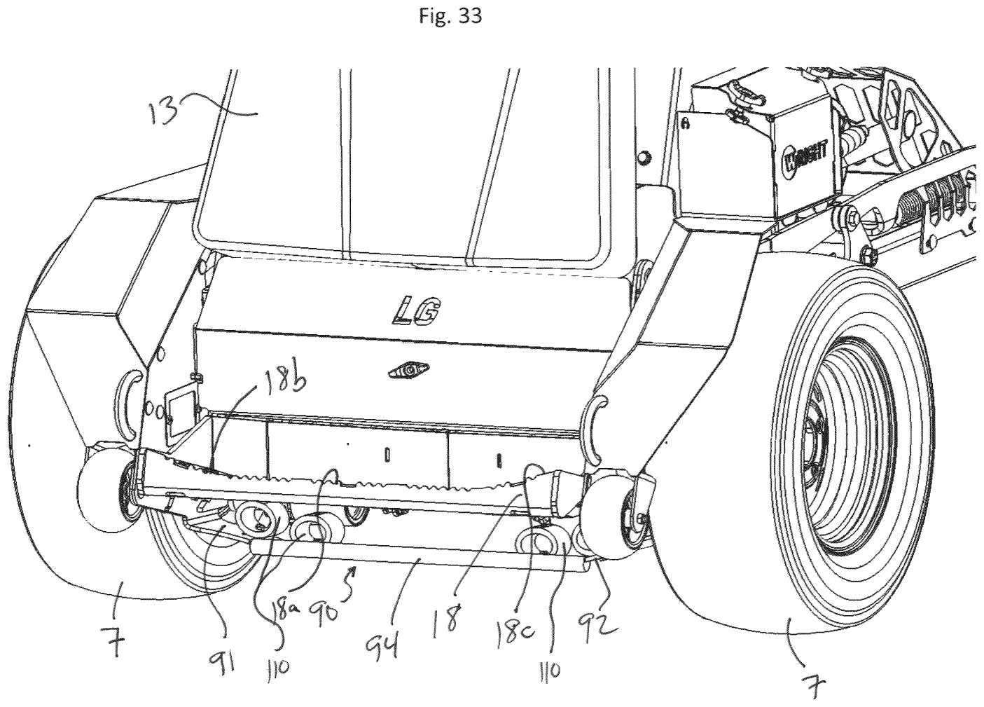

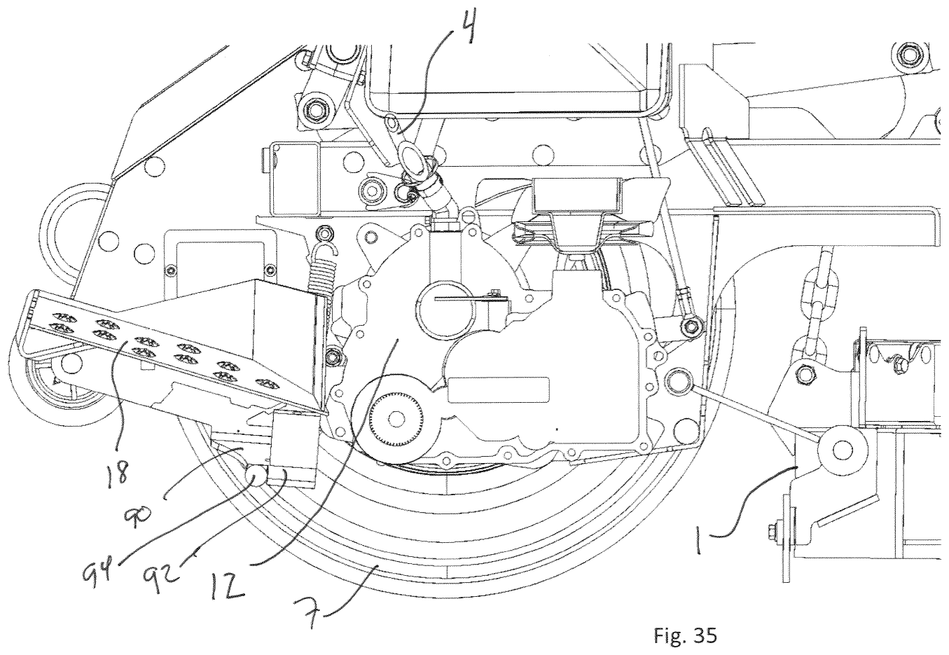

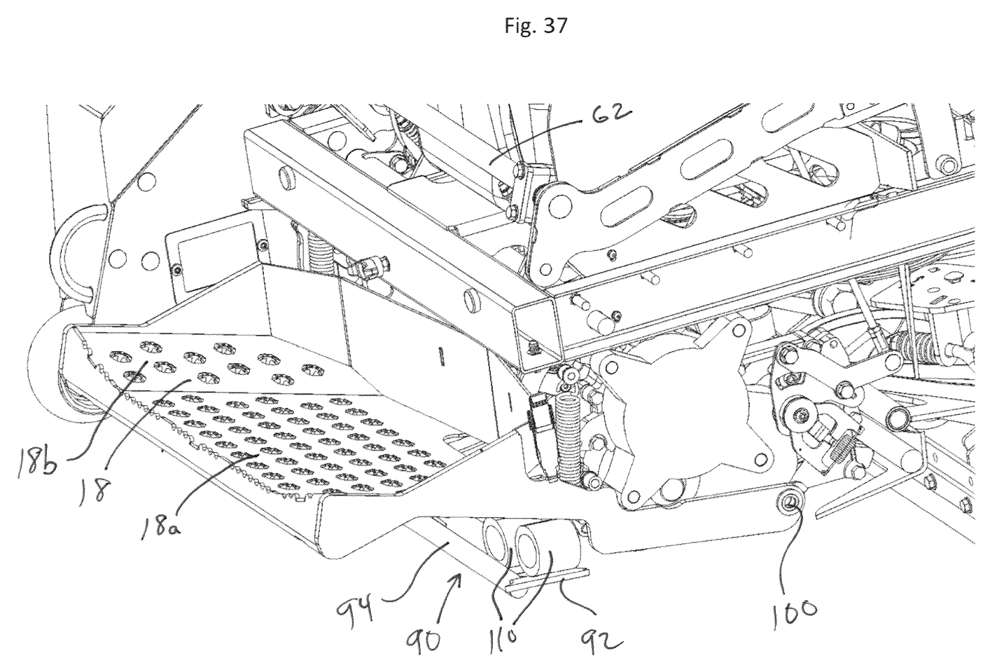

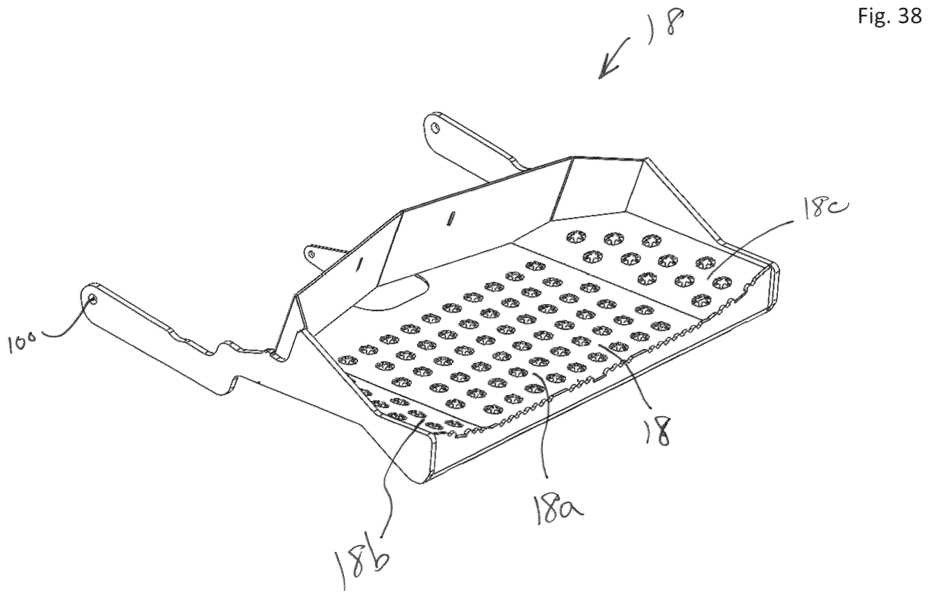

Referring to FIGS. 32-39, in certain example embodiments the mower may include a support 90 under and overlapping the footplate 18, where cross support members 91 and 92 of the support 90 are angled upwardly in order to increase clearance at bottom sides of the mower inside rear drive wheels 7, such as for improved curb clearance during mower operations and/or to provide for more efficient use of space. FIG. 32 is a perspective view of the mower on a curb 100 as viewed from a bottom rear of the mower, showing at least the pivotal footplate 18, support 90 under the footplate, and rear drive wheels 7 according to an example embodiment; whereas FIGS. 33-35 are from various angles showing at least the pivotal footplate 18, support 90 under the footplate 18, and rear drive wheels 7, with FIG. 35 illustrating that as viewed from the side support 90, which may include each of 91, 92, 93 94, may be entirely positioned within the radius of the rear wheel(s) 7 in order to provide protection for the support 90 in order to reduce chances of the support 90 hitting curbs or the like. FIGS. 36-37 are various cutaway views; FIG. 38 is a perspective view of the footplate 18; and FIG. 39 is a perspective view of frame structure/cross support member 102 which may include support 90 provided between a pair of vertically oriented sidewalls 104 and at an elevation beneath cross rail/tube 106. As shown in the figures, in certain example embodiments, pivotable footplate 18 may include a substantially flat central portion 18a for supporting feet of the operator, and angled side portions 18b and 18c which angle upwardly moving away from the central portion 18a. The foot support surfaces of footplate 18 may be textured and/or include holes, as shown in the figures, in order to provide for improved shoe gripping during mower operations, as shown in the figures. Footplate 18 may be of any suitable shape, and need not be flat, so long as it provides at least one foot support surface for at least one foot of a mower operator.

The support 90, which may be fixed and not pivotal, may include cross support members 91 and 92, and central portion 93 which may include a substantially flat portion and a cross bar portion 94. Central portion 93 may extend between at least the two cross supports 91 and 92. Central portion 93 may be configured to be substantially parallel to the ground during flat mower operations, whereas cross supports 91 and 92 are angled upwardly from the central portion 93 in a manner so as to angle upwardly away from the ground as they progress in location further form the central portion 93, as shown in the figures. These components may be of or include metal such as steel, or any other suitable material, in various example embodiments. In certain example embodiments, while footplate 18 may be pivotal (e.g., about pivot axis 100), support 90 may be fixed in position so that it does not pivot along with the footplate 18.

In certain example embodiments, still referring to FIGS. 32-39, side portions 18b and 18c of the footplate 18 may be oriented so that their foot supporting surfaces (e.g., for supporting respective feet of the operator during turns and/or sidehill operations) define an angle of from about 8-40 degrees, more preferably from about 10-30 degrees, more preferably from about 12-25 degrees, with the foot supporting surface of the substantially flat central portion 18a. In certain example embodiments, cross support members 91 and 92 of the support 90 may be substantially parallel to the foot support surfaces of the corresponding side portion 18b, 18c of the footplate which they are respectively under; and/or in certain example embodiments cross supports 91 and 92 may be respectively angled upwardly away from the ground at an angle of from about 8-40 degrees, more preferably from about 10-30 degrees, more preferably from about 12-25 degrees, in order to increase clearance at bottom sides of the mower inside rear drive wheels 7 in order to provide for improved curb clearance during mower operations and/or to provide for more efficient use of space. The angling of fixed cross supports 91 and 92, of the fixed support 90, provides for a more compact design with improved clearance over curbs and the like, and provides improved ergonomics during hill holding operations. The angling of fixed cross supports 91 and 92 is also advantageous in that it provides efficiently designed space for locating suspension elastomeric cushions 110 in a manner so that in certain example embodiments numerous of the same sized cushions 110 can be used at different locations between the support 90 and footplate 18, to essentially provide shock absorbers under the footplate.

A plurality of elastomeric cushions 110, of or including elastomeric material such as rubber or the like, may be provided between a bottom of footplate and a top of fixed support 90, in order to cushion vertical movement of the footplate during mower operations such as when travelling over curbs, roots, rocks, and/or the like. Four such elastomeric cushions 110 are shown in the figure, although any other suitable number may be provided. Elastomeric cushions 110 may be hollow as shown in the figures, or may be otherwise shaped in various other example embodiments. Elastomeric cushions 110 may be attached to the support 90 in certain example embodiments, so that one or more of the cushions 110 need not contact the bottom of the footplate 18 when the footplate 18 is in an upwardly pivoted position (e.g., such as when no operator is standing on it), and so that as the footplate 18 pivots about axis 100 during operations when one is standing on the footplate the bottom of footplate comes down and contacts the elastomeric cushions 110 on the fixed support 90 so that the ride of the operator is cushioned and/or footplate vibrations dampened.

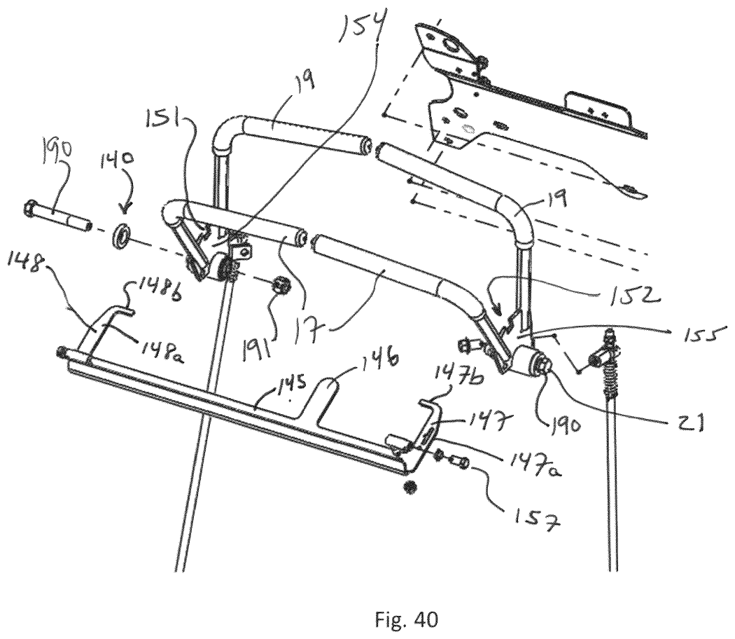

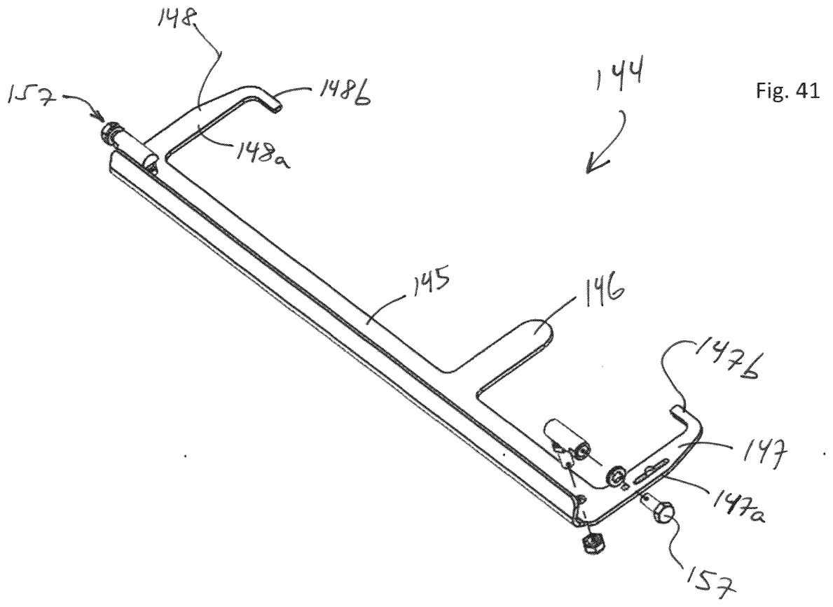

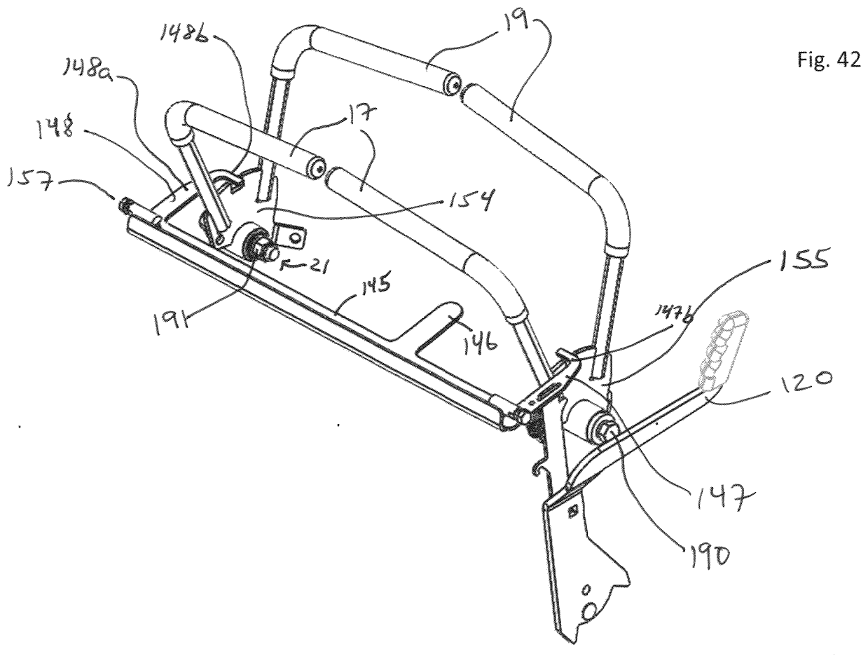

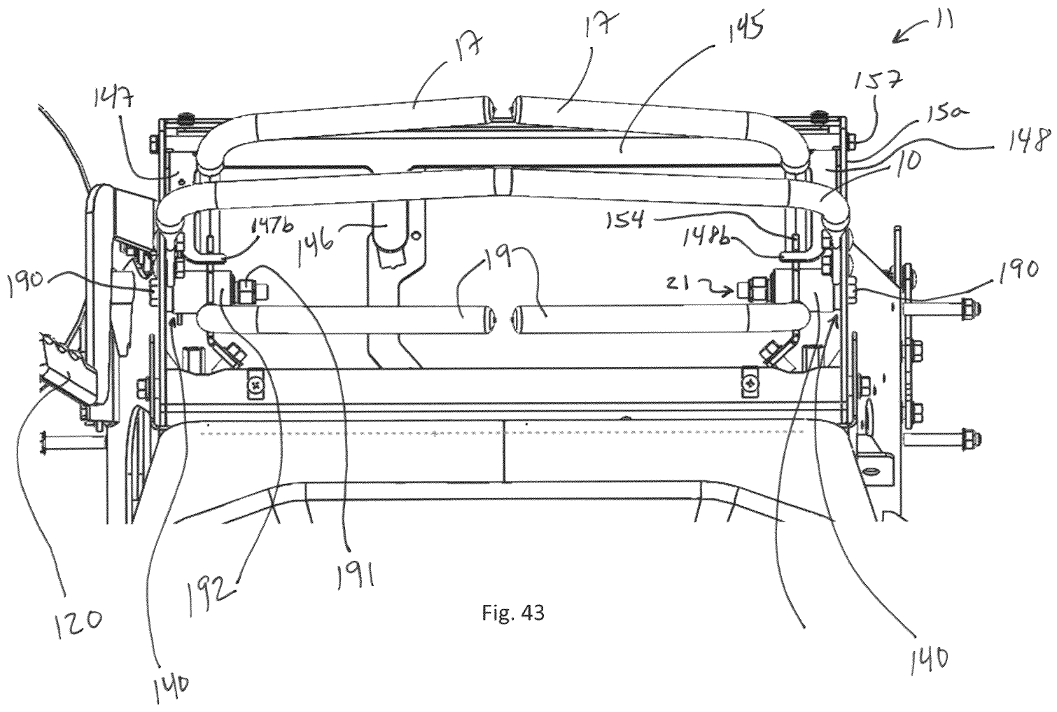

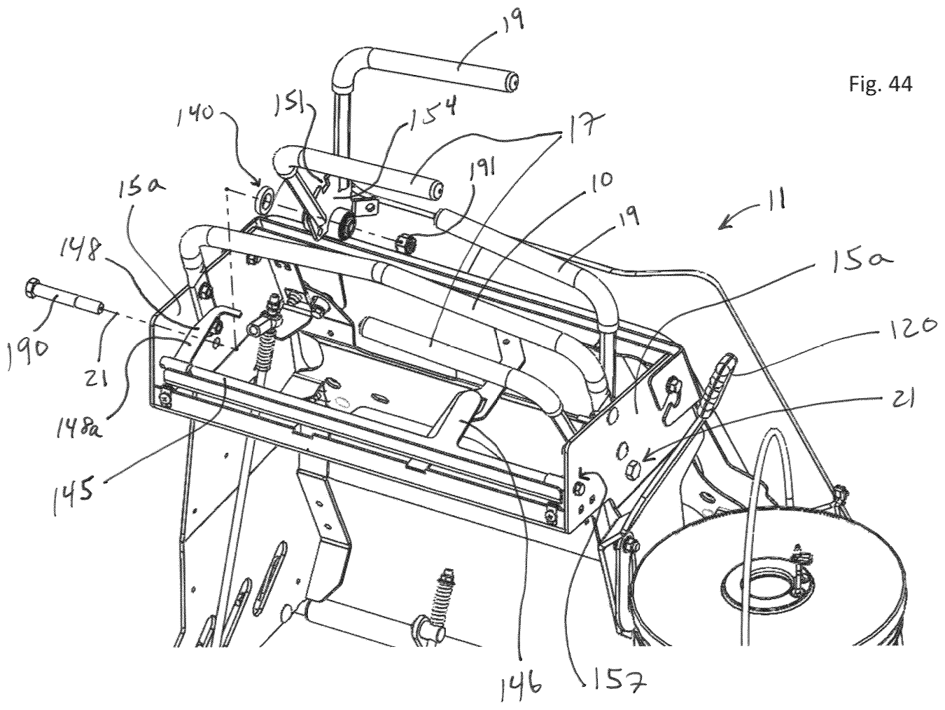

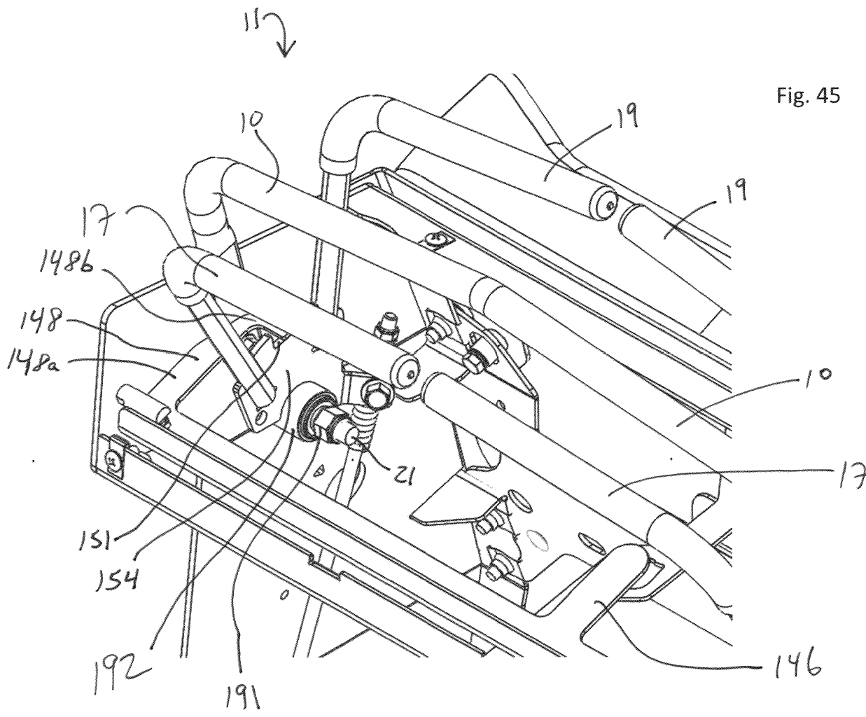

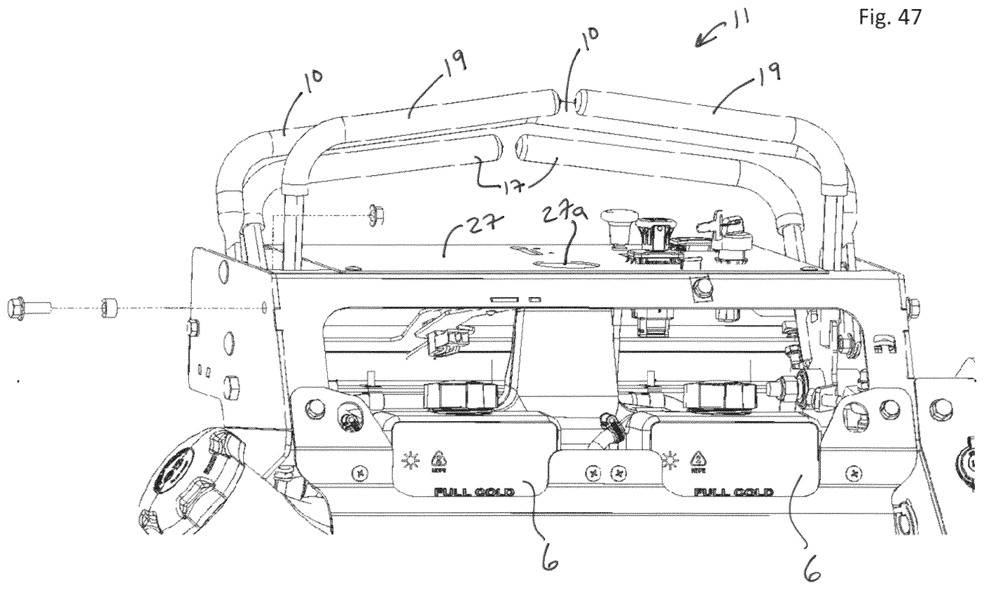

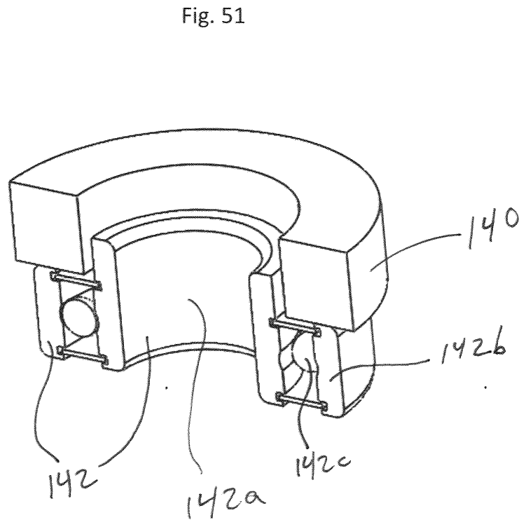

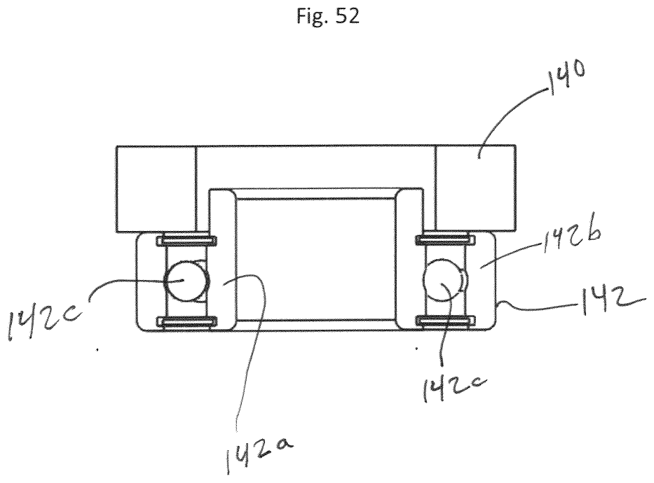

In certain example embodiments, there may be provided an improved interlock design for selectively locking mower pivotal hand controls 17, 19 upon pulling of a parking brake lever/handle 120; and/or at least one dampening washer (e.g., felt washer) 140 and bearing structure 142 positioned and configured to reduce vibration and/or oscillation/movement of pivotal mower hand controls 17, 19 (e.g., see FIGS. 40-52).

As shown in FIGS. 40-46, pivotal interlock 144 may include an elongated main body 145, extension 146 which extends and/or protrudes from main body 145, and substantially L-shaped and/or substantially C-shaped arms 148 and 147 each of which extends and/or protrudes from a respective end area of main body 145. Each arm 147 and 148 includes an elongated main body (147a or 148a, respectively) and a distal end (147b or 148b, respectively) that extends (e.g., at about a ninety degree angle) from the arm's main body. Notches and/or recesses 151 and 152 are provided in supports 154 and 155, respectively, with supports 154 and 155 being connected to and/or integral with handle control bars 17 and/or 19 so as to pivot therewith about axis 21. When distal end 148b of arm 148 is positioned at least partially in recess (e.g., notch) 151, and/or distal end 147b of arm 147 is positioned at least partially in recess (e.g., notch) 152, supports 154 and 155 are substantially locked in position so that hand controls 17 and 19 cannot move very much (e.g., they may move a small amount corresponding to the amount of extra space in the recesses 151, 152, but cannot be used to reasonably steer the mower). Thus, when distal end 148b of arm 148 is positioned at least partially in recess (e.g., notch) 151, and/or distal end 147b of arm 147 is positioned at least partially in recess (e.g., notch) 152, supports 154 and 155 are substantially locked in position so that hand controls 17 and 19 cannot be used to reasonably steer the mower, whereby the hand controls are locked out. However, when distal end 148b of arm 148 is not positioned at least partially in recess (e.g., notch) 151, and distal end 147b of arm 147 is not positioned at least partially in recess (e.g., notch) 152, supports 154 and 155 are not locked out and the hand controls 17 and 19 can be used to steer the mower during mowing operations.

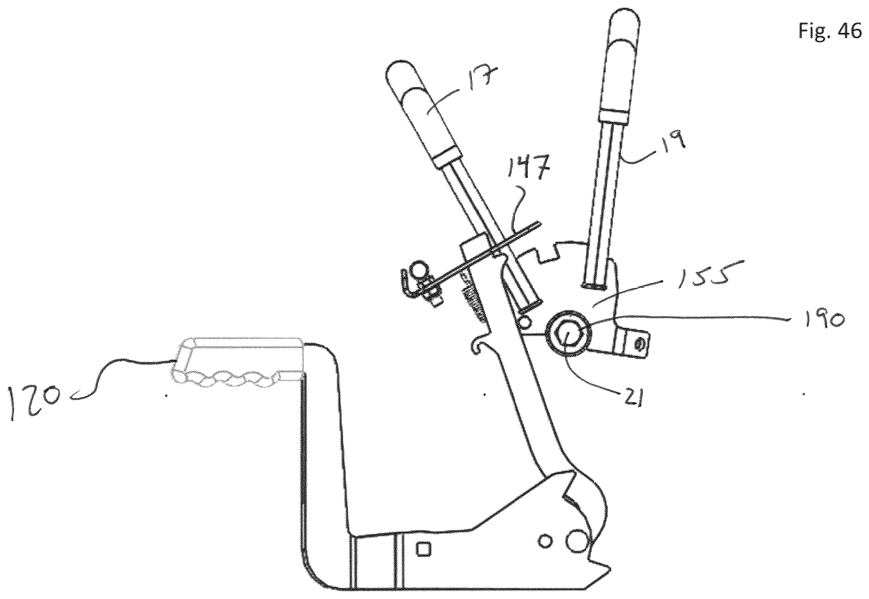

Distal end 148b of arm 148 is moved based on the position of parking brake lever/handle 120. In certain example embodiments, when parking brake lever/handle 120 is in a brake-off position as shown in FIG. 46, the parking brake is off and distal end 148b of arm 148 is not positioned at least partially in recess (e.g., notch) 151, and distal end 147b of arm 147 is not positioned at least partially in recess (e.g., notch) 152, so that supports 154 and 155 are not locked out and the hand controls 17 and 19 can be used to steer the mower. However, when parking brake lever/handle 120 is pulled or otherwise manipulated from the brake-off position to a brake-on position (e.g., see brake-on position shown in FIGS. 1, 42, 43, and 45), the parking brake is on and distal end 148b of arm 148 is positioned at least partially in recess (e.g., notch) 151, and/or distal end 147b of arm 147 is positioned at least partially in recess (e.g., notch) 152, so that supports 154 and 155 are substantially locked in position so that hand controls 17 and 19 cannot be used to reasonably steer the mower. In certain example embodiments, pulling the parking brake lever/handle 120 causes the interlock 144 to pivot about axis 157 where rod ends and/or bolts extend through upper supports 15a, so that as the interlock 144 pivots the arms 147 and 148 move downward so that distal ends 147b and 148b thereof move into recesses (e.g., notches) 152 and 151 respectively. When the parking brake lever/handle 120 is moved from the brake-on position to the brake-off position, this causes the parking brake to be released and also causes arms 147 and 148 move upward and out of recesses 152 and 151 so that the locking out of the handle controls is released. In such a manner, the parking brake lever/handle 120 can be used to selectively move the distal ends of arms 148, 147 into and out of engagement with recesses 151, 152 so as to selectively lock-out steering ability of the hand controls 17 and 19.

In previous designs, interlock arms have been located on the interior side (i.e., inboard side) of the supports 154 and 155, so as to each be located between the supports 154 and 155. However, in certain example embodiments and as shown in FIGS. 40-46, arms 147 and 148 are located on the exterior side (i.e., outboard side) of supports 154 and 155, so that arm 148 is at least partially or mostly located between support 154 and the move closely adjacent upper support 15a, and arm 147 is at least partially or mostly located between support 155 and the most closely adjacent upper support 15a as viewed from above. As viewed from above, elongated main bodies 147a and 148a are not located between supports 154 and 155. Supports 154 and 155 may also be referred to as handle flanges in certain example embodiments. This design is technically advantageous because it allows the hand controls 17 and 19 to be more easily removed from the mower for maintenance or the like, and improves manufacturability of the mower. With this design, as shown in FIGS. 40-46, interlock 144 does not need to be removed in order to remove the hand controls 17 and 19 from the mower, thereby making hand control removal much easier and more efficient. To remove the hand controls 17 and 19 with out removing the interlock 144, the hand controls can be disconnected, slid laterally, and one end lifted for removal. Such features may be utilized on any type of mower, such as stand-on mowers, walk behind mowers, or sit-down mowers.

Referring to FIGS. 40-52, the pivot axis 21 of hand controls 17 and 19 is at least partially formed by a pivot bolt 190 on each side of the mower protruding at least partially through a corresponding upright 15a, nut 191 on each pivot bolt 190, and cylindrical housings 192 on each side of the mower each of which at least partially houses bearings 142 and 195. In certain example embodiments, a control washer 140 is provided on each side of the mower between at least the housing 192 and upright 15a in order to dampen vibration and/or reduce oscillation of the handle controls 17 and 19 when the mower's engine is running. Surprisingly and unexpectedly, it has been found that when at least one of the washers 140 is or includes a felt washer, a marked improvement of dampening vibration and/or reducing oscillation of the handle controls 17 and 19 when the mower's engine is running is provided. For example, it has surprisingly been found that rubber washers do not perform well for this task—it is possible that rubber washers provide too much friction. It has also surprisingly been found that metal wave washers and metal bellville washers also do not perform well for this task—again, it is believed that these washers may provide for too much friction. Thus, it has surprisingly and unexpectedly been found that felt washers for use as control washers 140 provide for unexpectedly improved results compared to other types of washers such as rubber washers, metal wave washers, and metal bellville washers.

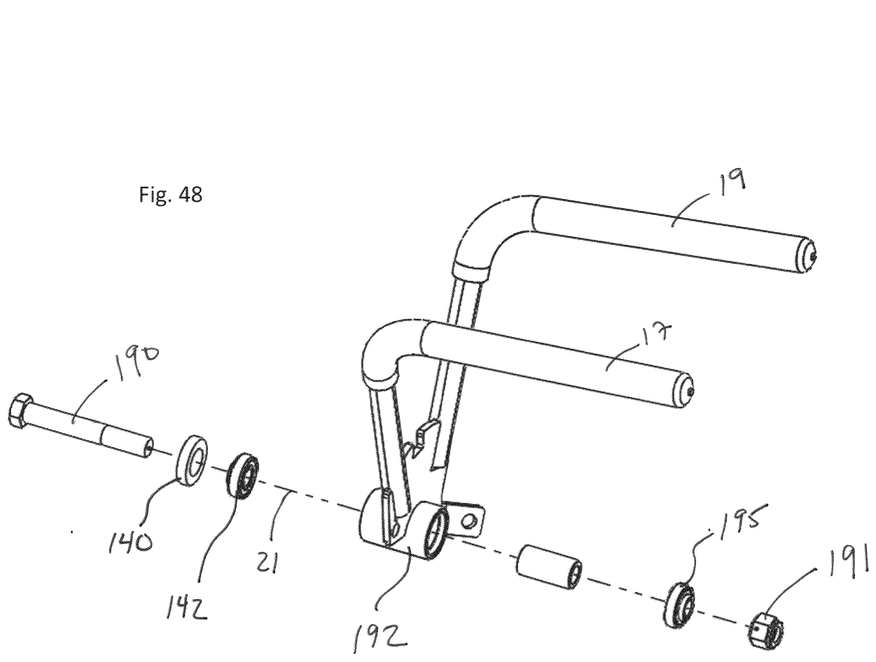

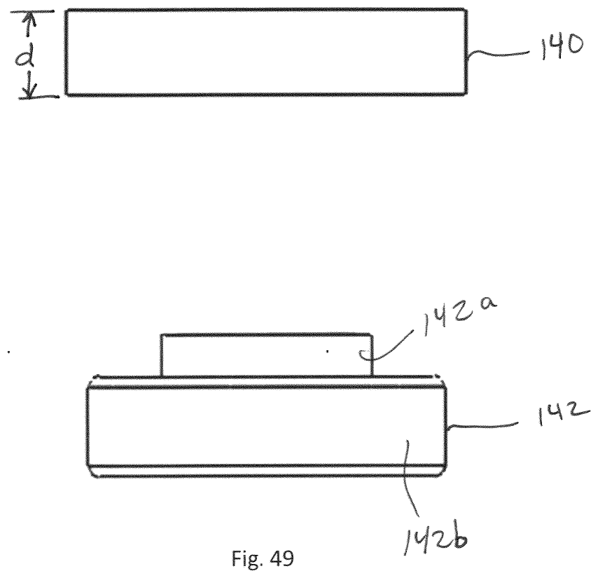

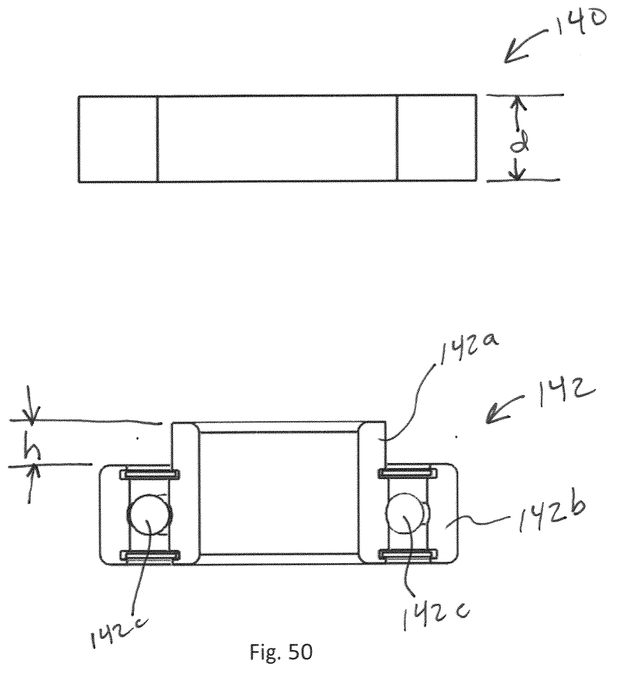

Referring to FIGS. 48-52, bearing 142 is at least partially positioned in the outboard side of cylindrical housing 192, one on each side of the mower. FIGS. 49-52 illustrate that, in certain example embodiments, bearing 142 includes a fixed inner race 142a and a rotatable outer race 142b. Ball bearings 142c are provided between the inner and outer races. A portion of fixed inner race 142a protrudes beyond rotatable outer face 142b, and felt washer 140 is at least partially mounted on the protruding portion of inner race 142a as shown in FIGS. 50-52. The central hole in felt washer 140 fits over and surrounds the protruding portion of inner race 142a as viewed along the rotating axis. Thus, the felt washer is at least partially supported by the fixed inner race on each side of the mower, and does not contact pivot bolt 190. The felt washer 140 also may contact upright 15a so as to provide a small amount of friction with the upright, so that at least part of felt washer 140 protrudes beyond cylindrical housing 192 on each side of the mower. In certain example embodiments, thickness “d” of the felt washer 140 is greater than the distance and/or height “h” that fixed inner race 142a protrudes beyond rotatable outer face 142b as shown in FIG. 50, thereby allowing the felt washer 140 to contact upright 15a and provide a small amount of friction with the upright.

It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). Terms, such as “first”, “second”, and the like, may be used herein to describe various components. Each of these terminologies is not used to define an essence, order or sequence of a corresponding component but used merely to distinguish the corresponding component from other component(s). For example, a “first” component may be referred to as a “second” component, and similarly, the “second” component may be referred to as the “first” component. “Or” as used herein may cover both “and” and “or.”

It should be noted that if it is described that one component is “connected”, “coupled”, or “joined” to another component, at least a third component(s) may be “connected”, “coupled”, and “joined” between the first and second components, although the first component may be directly connected, coupled, or joined to the second component. Thus, terms such as “connected” and “coupled” cover both direct and indirectly connections and couplings.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

The word “about”as used herein means the identified value plus/minus 5%.

“On” as used herein covers both directly on, and indirectly on with intervening element(s) therebetween. Thus, for example, if element A is stated to be “on” element B, this covers element A being directly and/or indirectly on element B. Likewise, “supported by” as used herein covers both in physical contact with, and indirectly supported by with intervening element(s) therebetween.

Each embodiment herein may be used in combination with any other embodiment(s) described herein.

While the disclosure has been illustrated and described with reference to various example embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in combination with any other embodiment(s) described herein.

1. A lawn mower comprising:
at least one cutting blade configured to be driven for cutting grass;
a footplate configured to support feet of a standing operator of the mower during mower operations, wherein the footplate comprises a foot supporting surface including a central portion and first and second side portions for supporting respective feet of the operator during turns and/or sidehill operations, the central portion being located between at least the first and second side portions of the foot supporting surface, at least part of each of the first and second side portions of the foot supporting surface defining an angle of from about 8-40 degrees with the central portion of the foot supporting surface; and
a support under and at least partially overlapped by the footplate, wherein the support comprises a central support portion between at least first and second cross supports, wherein at least part of the first and second cross supports of the support are each angled upwardly from the central support portion of the support by from about 8-40 degrees in order to increase clearance at bottom sides of the mower.

2. The mower of claim 1, wherein the footplate is pivotal and is configured to pivot about an axis during mower operations, and wherein the support under the footplate is not pivotal so as to not pivot with the footplate.

3. The mower of claim 1, wherein as viewed from a side of the mower the support, including the central support portion and the first and second cross supports, is entirely located within a radius of at least one of first and second rear drive wheels of the mower.

4. The mower of claim 1, wherein the central support is configured to be substantially parallel to the ground during flat ground mower operations.

5. The mower of claim 1, wherein each of the first and second side portions of the foot supporting surface defining an angle of from about 10-30 degrees with the central portion of the foot supporting surface, and wherein the first and second cross supports of the support are each angled upwardly from the central support portion of the support by from about 10-30 degrees.

6. The mower of claim 1, wherein the first and second side portions of the foot supporting surface of the footplate are substantially parallel to the first and second cross supports of the support, respectively.

7. The mower of claim 1, wherein the first and second cross supports and the central portion are located between first and second substantially vertically oriented sidewalls.

8. The mower of claim 1, wherein the foot supporting surface of the footplate is textured and includes a plurality of apertures defined therein.

9. The mower of claim 1, further comprising a plurality of elastomeric cushions positioned between a bottom of the footplate and the support, in order to cushion pivotal movement of the footplate during mower operations.

10. The mower of claim 1, further comprising a pivotal thigh pad configured to support at least thighs of the operator during mower operations.

11. The mower of claim 1, wherein the central portion of the foot supporting surface is substantially flat.

12. The mower of claim 1, wherein the central portion of the foot supporting surface of the footplate is contiguous to the first and second side portions of the foot supporting surface.

13. The mower of claim 1, wherein the footplate is at least partially located between first and second rear drive wheels of the mower.
